(19) United States
(12) Patent Application Publication
(10) Pub. No.: US 2022/0067256 A1
(43) Pub. Date: Mar. 3, 2022

(54) SIMULATION METHOD AND SIMULATION DEVICE

(71) Applicants: SUMITOMO ELECTRIC INDUSTRIES, LTD., Osaka (JP); NATIONAL UNIVERSITY CORPORATION HOKKAIDO UNIVERSITY, Hokkaido (JP)

(72) Inventors: Kenya NISHIGUCHI, Osaka (JP); Tamotsu HASHIZUME, Hokkaido (JP)

(21) Appl. No.: 17/445,757

(22) Filed: Aug. 24, 2021

(30) Foreign Application Priority Data
Aug. 28, 2020 (JP) 2020-144932

(51) Int. Cl. G06F 30/36

(52) U.S. Cl. CPC G06F 30/36; H01L 29/7786

(57) ABSTRACT

With respect to a method of simulating a capacitance-voltage (C-V) characteristic of a laminated structure that includes a semiconductor, an insulator provided on the semiconductor, and a metal provided on the insulator, and that includes multiple discrete interface states, at which electrons are trapped or emitted in response to a change of a voltage applied to the metal, at an interface between the semiconductor and the insulator, the method includes calculating a first capacitance in accordance with a first voltage applied to the metal, and calculating a second capacitance from a quantity of electrons emitted from a first interface state corresponding to the first voltage among the multiple discrete interface states. The calculating of the second capacitance includes changing the first voltage in stages and shifting the first interface state in stages.

### CROSS-REFERENCE TO RELATED APPLICATIONS

This application is based upon and claims priority to Japanese Patent Application No. 2020-144932 filed on Aug. 28, 2020, the entire contents of which are incorporated herein by reference.

### BACKGROUND OF THE INVENTION

### 1. Field of the Invention

The present disclosure relates to a simulation method and a simulation device.

### 2. Description of the Related Art

Interface states exist at the interface between a semiconductor and an insulating film included in a semiconductor device, and interface states affect characteristics of the semiconductor device. For example, the current collapse of a high electron mobility transistor (HEMT) using GaN is closely related with the interface state density. Generally, as the interface state density increases, the frequency dependence of the capacitance-voltage (C-V) characteristic increases. Therefore, at a design stage of the semiconductor device, an attempt is made to quantify the interface state through numerical calculation analysis of the C-V characteristic by using simulation.

The accuracy of conventional methods of simulating the C-V characteristic is low when the frequency is as low as about 1 Hz to 1 kHz.

It is desired to provide a simulation method and a simulation device that achieve improved accuracy even when the frequency is low.

### RELATED-ART DOCUMENTS

### Patent Documents

Patent Document 1: Japanese Laid-Open Patent Publication No. 2003-092319

### Non-Patent Document

[Non-Patent Document 1] J. Appl. Phys. 63 (1988) 2120

[Non-Patent Document 2] J. Appl. Phys. 103 (2008) 104510

[Non-Patent Document 3] J. Appl. Phys. 57 (2018) 04FG04

### SUMMARY OF THE INVENTION

According to one aspect of the present disclosure, a simulation method of the present disclosure is a method of simulating a capacitance-voltage (C-V) characteristic of a laminated structure including a semiconductor, an insulator provided on the semiconductor, and a metal provided on the insulator. The method uses a model of the C-V characteristic of the laminated structure that includes multiple discrete interface states, at which electrons are trapped or emitted in response to a change of a voltage applied to the metal, at an interface between the semiconductor and the insulator. The model of the C-V characteristic represents a third capacitance in response to the change of the voltage, the third capacitance including a first capacitance of a depletion layer foiled at the interface, a second capacitance of the multiple discrete interface states, and a capacitance of the insulator. The first capacitance and the second capacitance are connected in parallel, and the capacitance of the insulator is connected in series with the first capacitance and the second capacitance connected in parallel. The method includes calculating the first capacitance in accordance with a first voltage applied to the metal, and calculating the second capacitance from a quantity of electrons emitted from a first interface state corresponding to the first voltage among the multiple discrete interface states. The calculating of the second capacitance includes changing the first voltage in stages and shifting the first interface state in stages.

According to one embodiment of the present disclosure, improved accuracy can be achieved even when the frequency is low.

### BRIEF DESCRIPTION OF THE DIAGRAMS

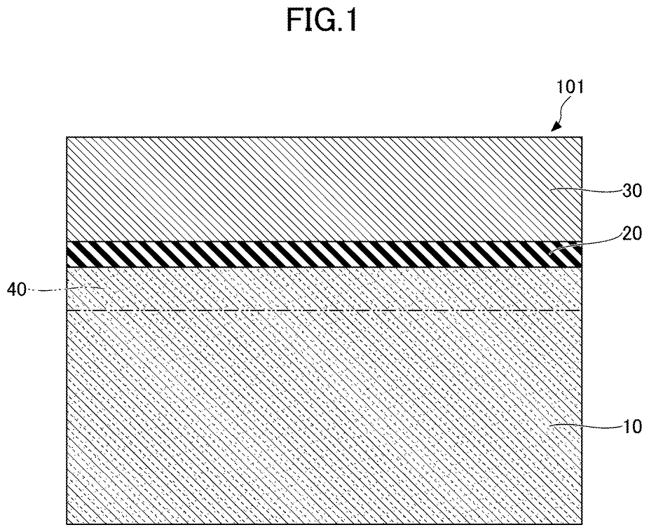

FIG. 1 is a cross-sectional view illustrating an object of a simulation method according to a first embodiment;

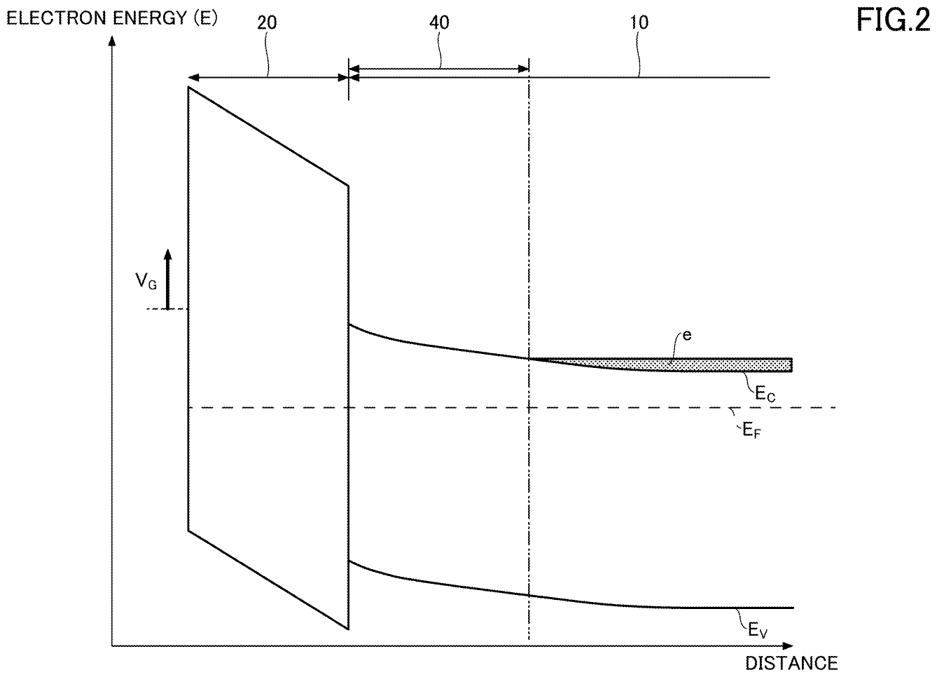

FIG. 2 is a band diagram illustrating ideal potential distribution in the object illustrated in FIG. 1;

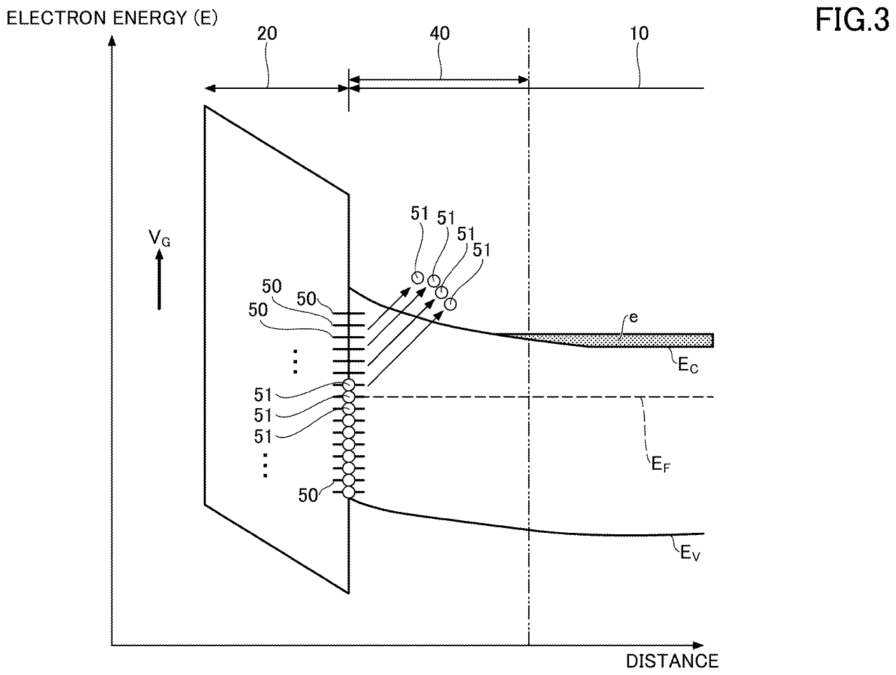

FIG. 3 is a band diagram illustrating potential distribution in consideration of interface states in the object illustrated in FIG. 1;

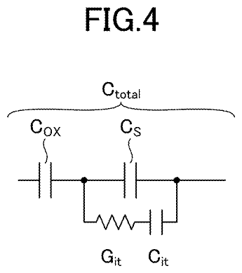

FIG. 4 is a diagram illustrating an equivalent circuit of the band structure illustrated in FIG. 3;

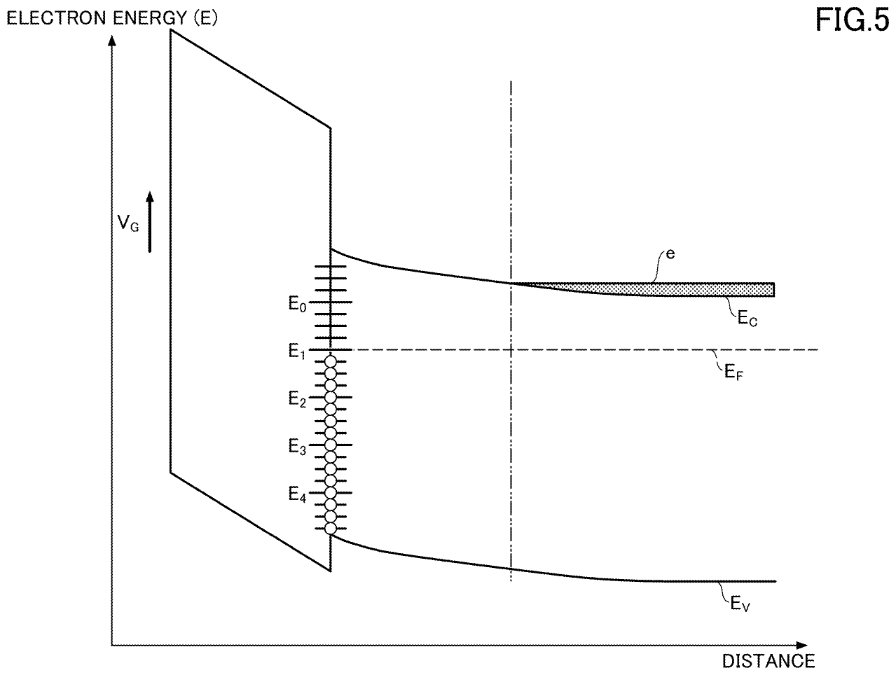

FIG. 5 is a band diagram illustrating potential distribution in a laminated structure used in a simulation method according to the first embodiment;

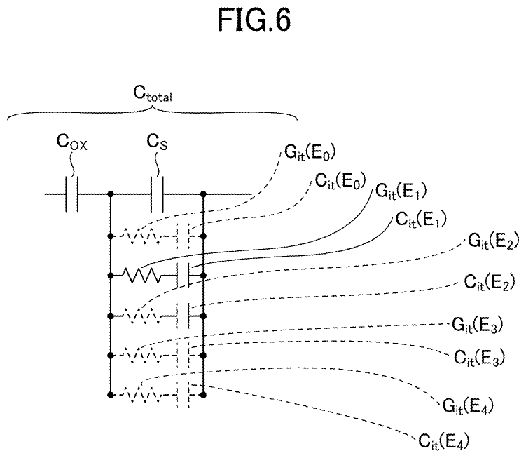

FIG. 6 is a diagram illustrating an equivalent circuit of the band structure illustrated in FIG. 5;

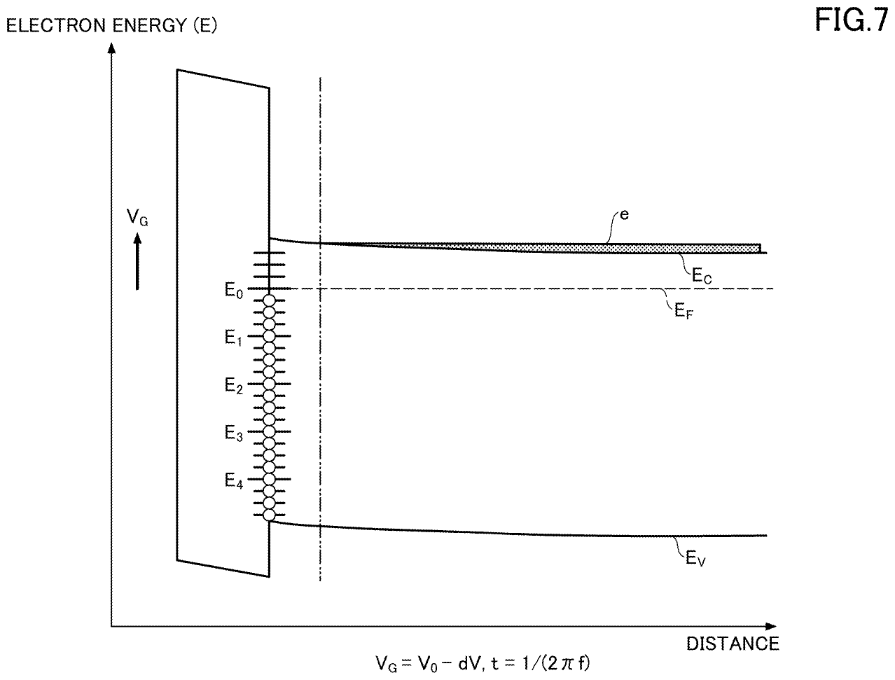

FIG. 7 is a first band diagram illustrating a change in potential distribution that is caused by a change in the voltage applied to a metal in the first embodiment;

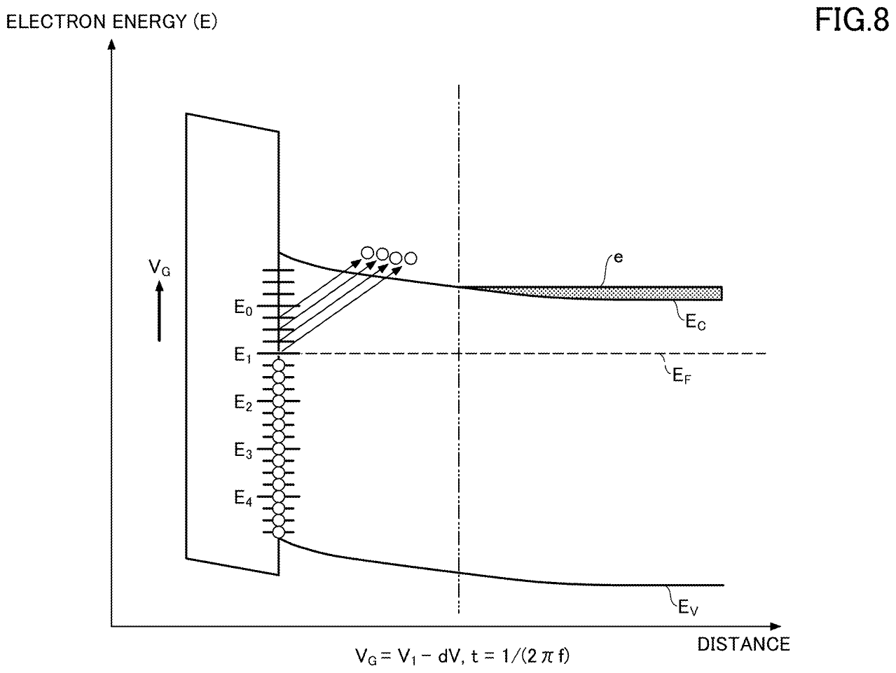

FIG. 8 is a second band diagram illustrating the change in potential distribution that is caused by the change in the voltage applied to a metal in the first embodiment;

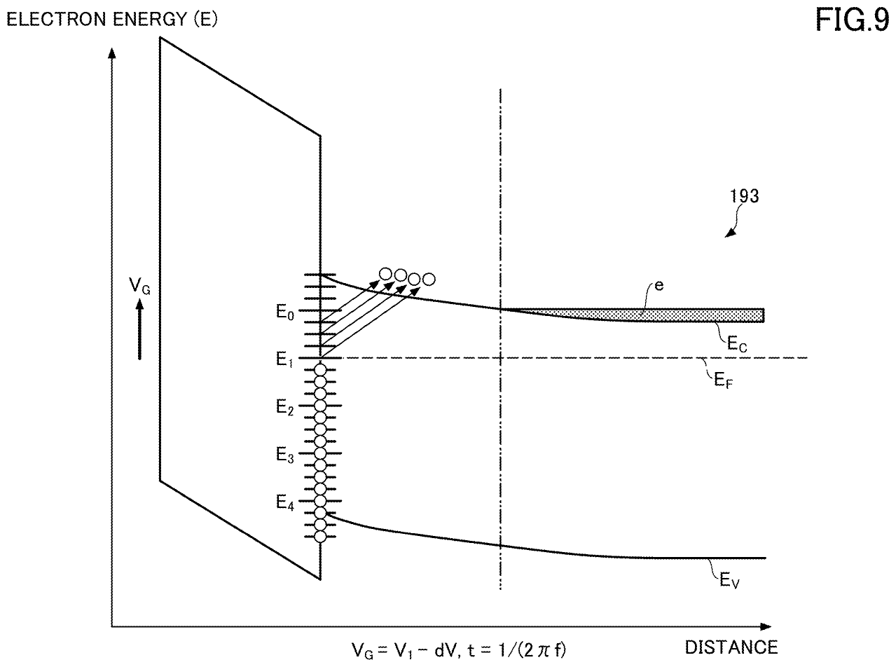

FIG. 9 is a third band diagram illustrating the change in potential distribution that is caused by the change in the voltage applied to a metal in the first embodiment;

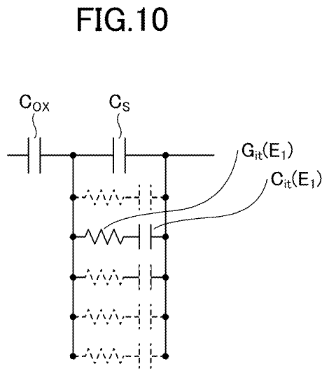

FIG. 10 is a diagram illustrating an equivalent circuit of the band structure illustrated in FIG. 9;

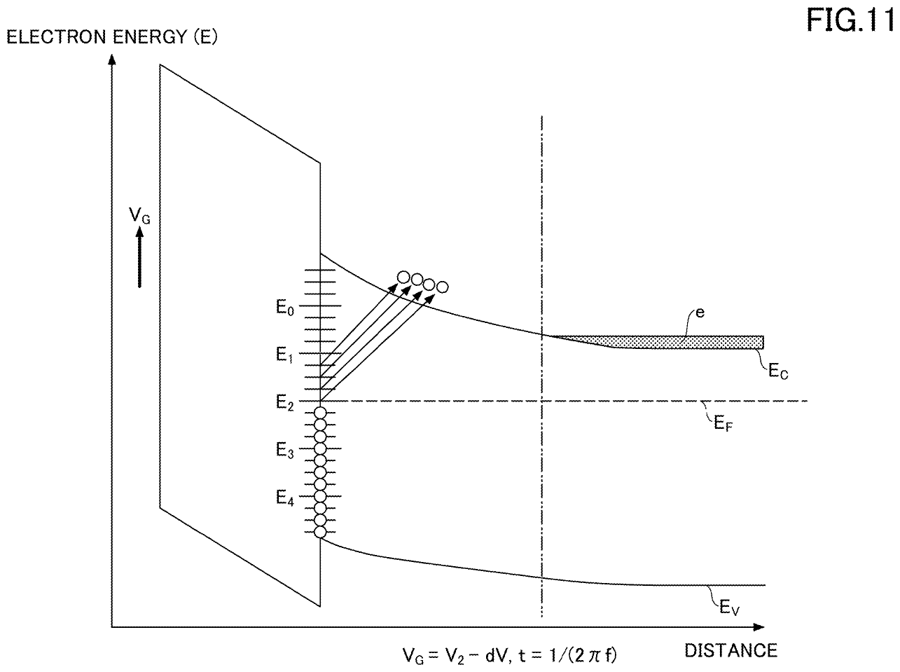

FIG. 11 is a fourth band diagram illustrating the change in potential distribution that is caused by the change in the voltage applied to a metal in the first embodiment;

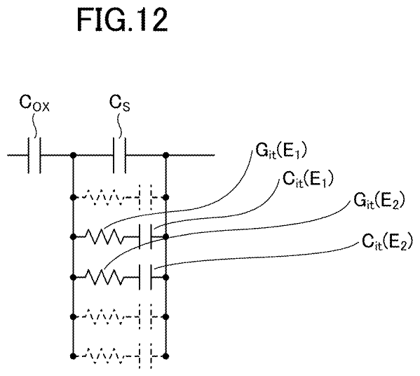

FIG. 12 is a diagram illustrating an equivalent circuit of the band structure illustrated in FIG. 11;

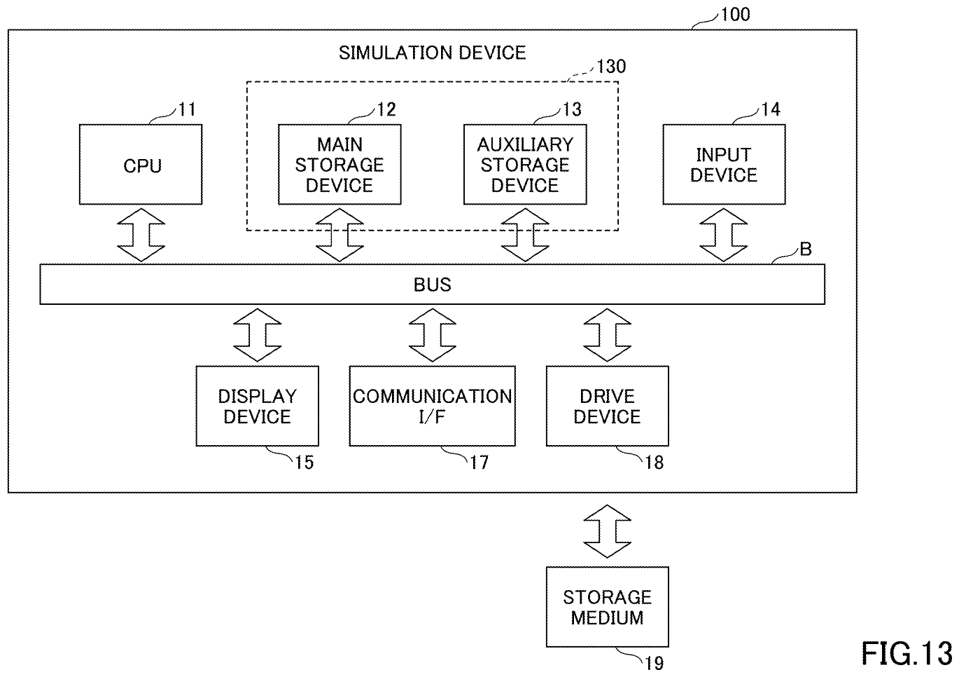

FIG. 13 is a diagram illustrating a hardware configuration of a simulation device;

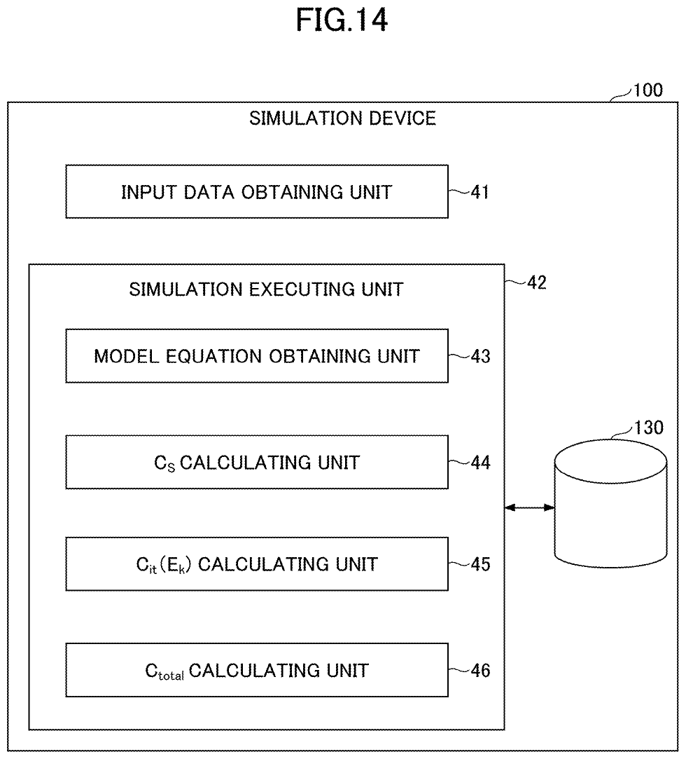

FIG. 14 is a diagram illustrating a functional configuration of the simulation device;

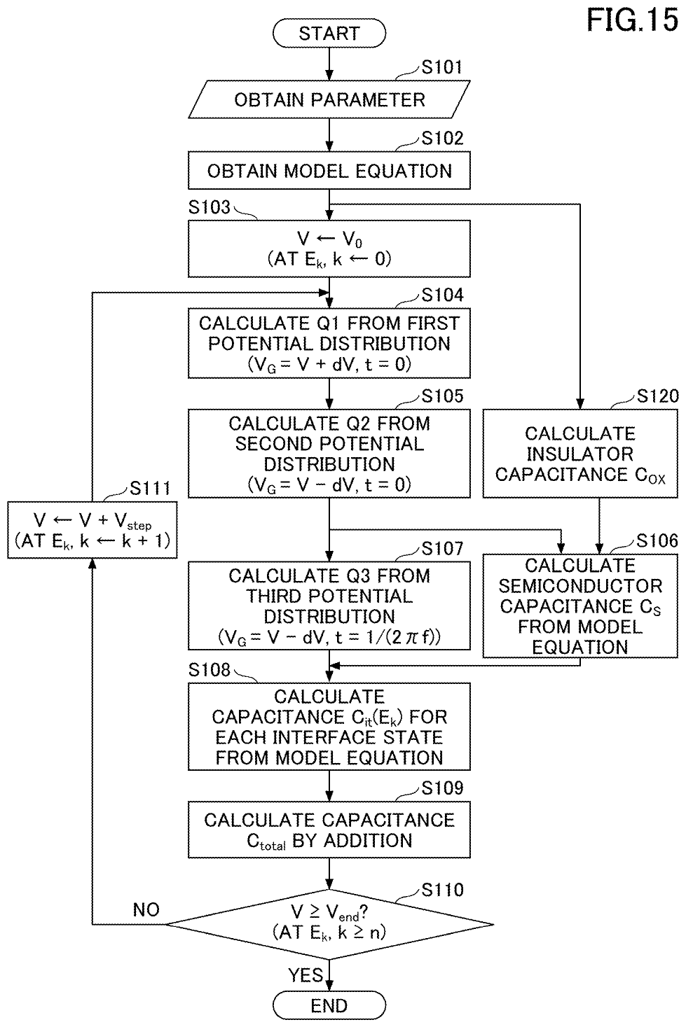

FIG. 15 is a flowchart illustrating a simulation method performed by the simulation device;

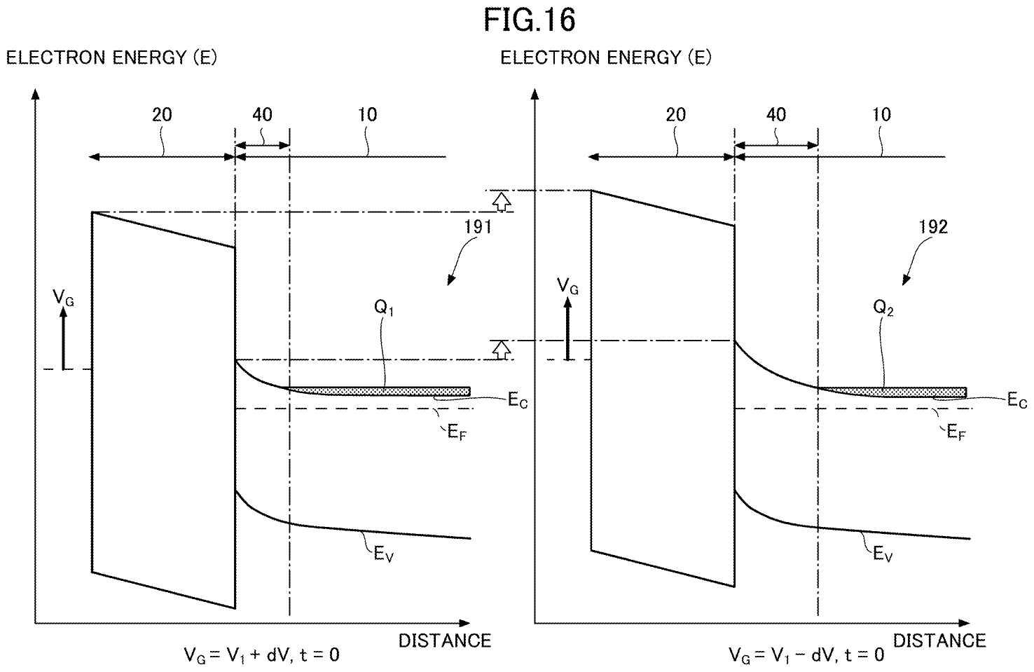

FIG. 16 is a diagram illustrating first potential distribution and second potential distribution in the first embodiment, arranged side by side;

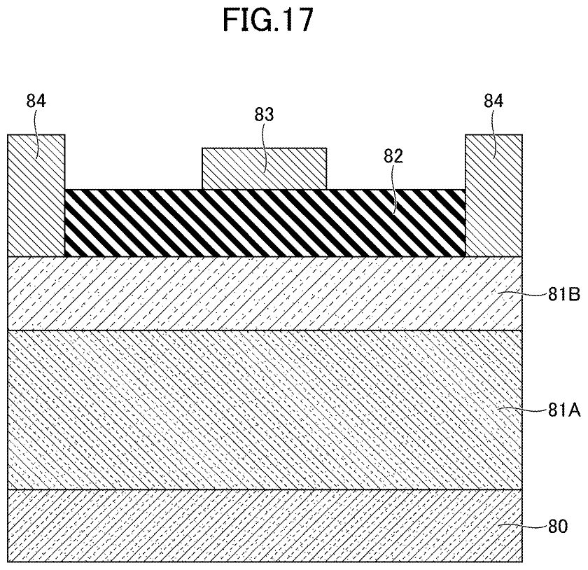

FIG. 17 is a cross-sectional view illustrating the laminated structure of the object of the simulation according to the first embodiment;

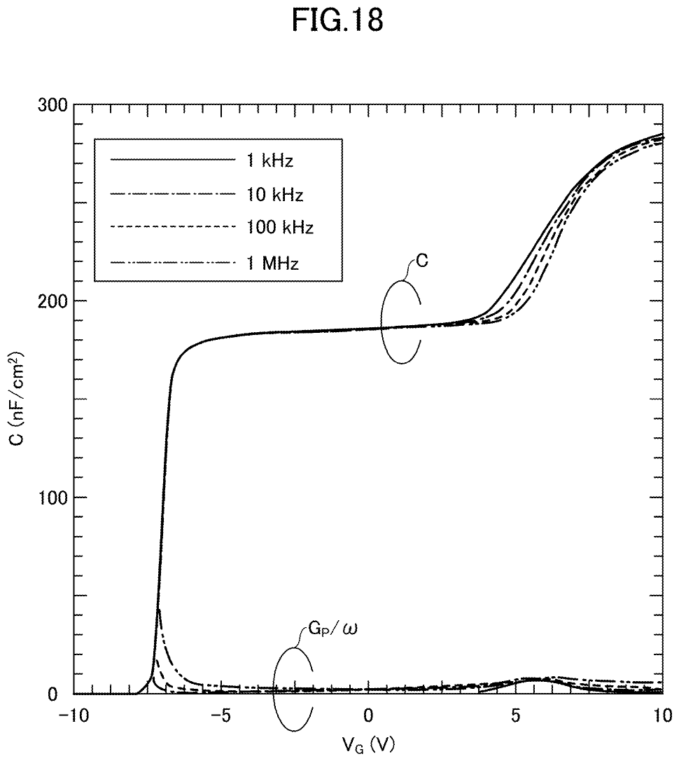

FIG. 18 is a graph illustrating a simulation result of the laminated structure illustrated in FIG. 17;

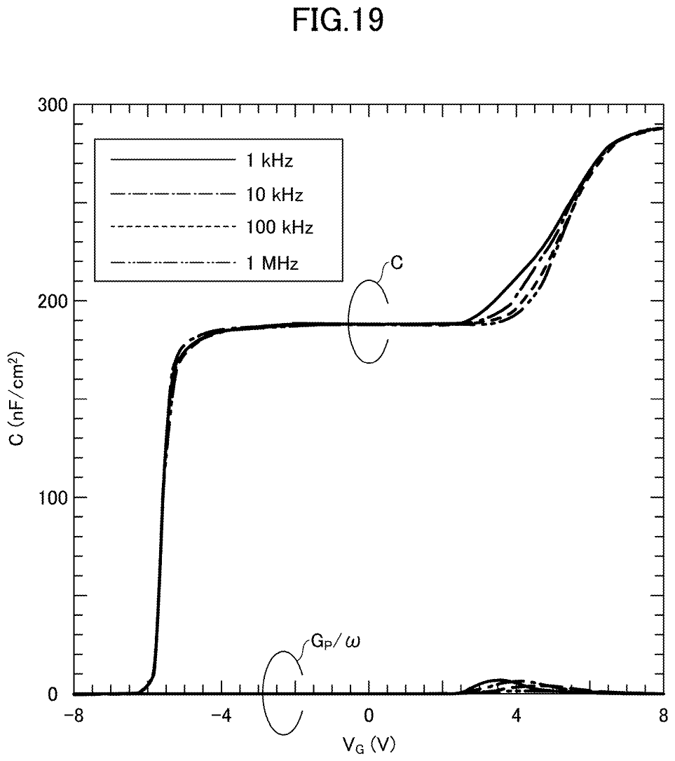

FIG. 19 is a graph illustrating an actual measurement result of the laminated structure illustrated in FIG. 17;

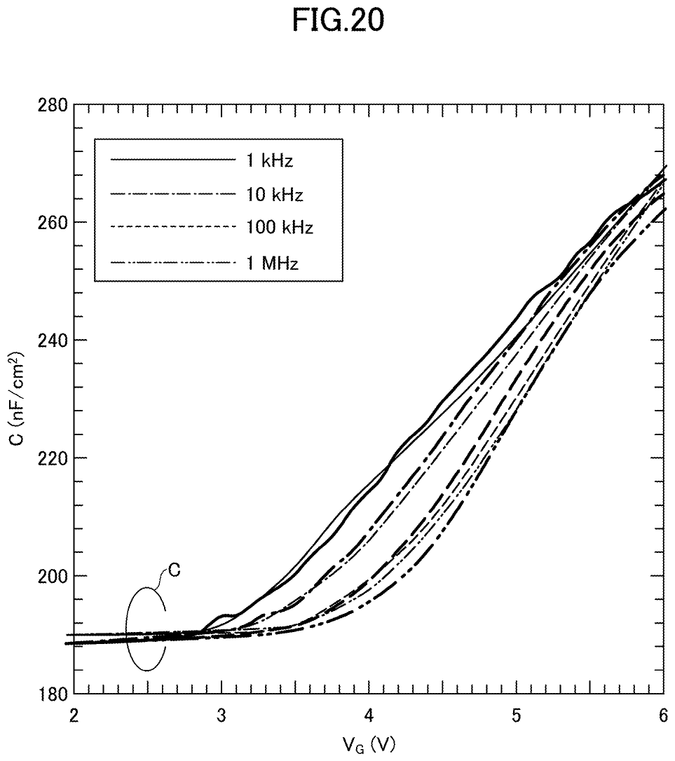

FIG. 20 is a graph illustrating the simulation result and the actual measurement result, overlapping with each other, related to the first embodiment;

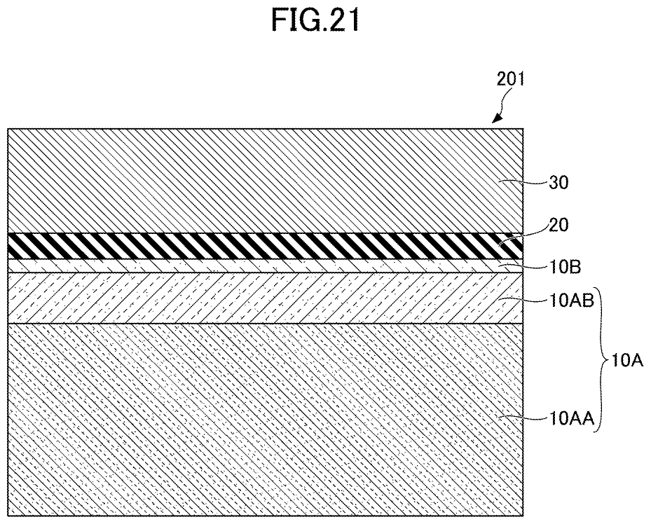

FIG. 21 is a cross-sectional view illustrating an object of a simulation method according to a second embodiment;

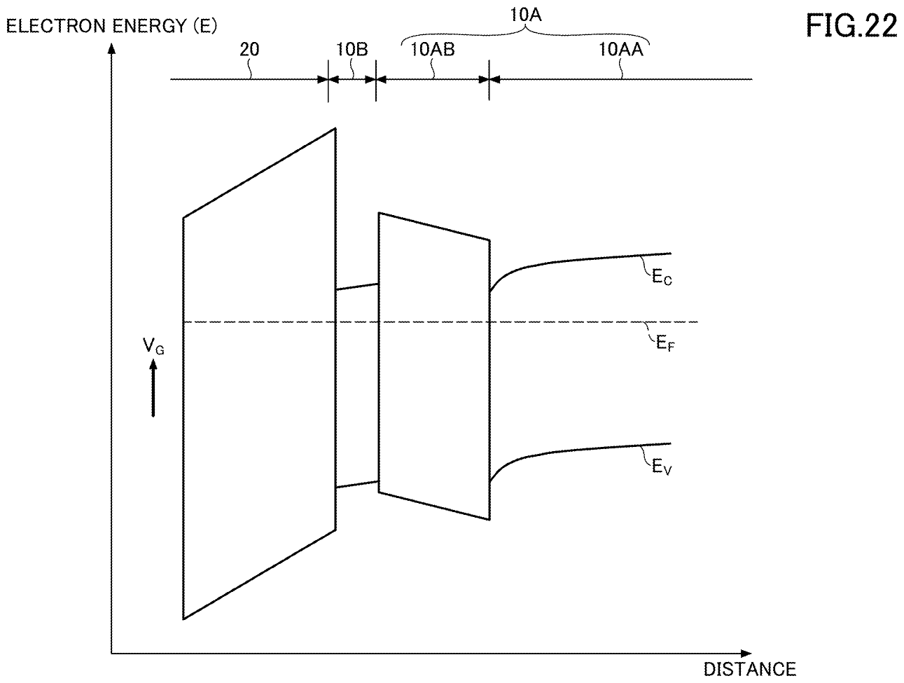

FIG. 22 is a band diagram illustrating ideal potential distribution in the object illustrated in FIG. 21;

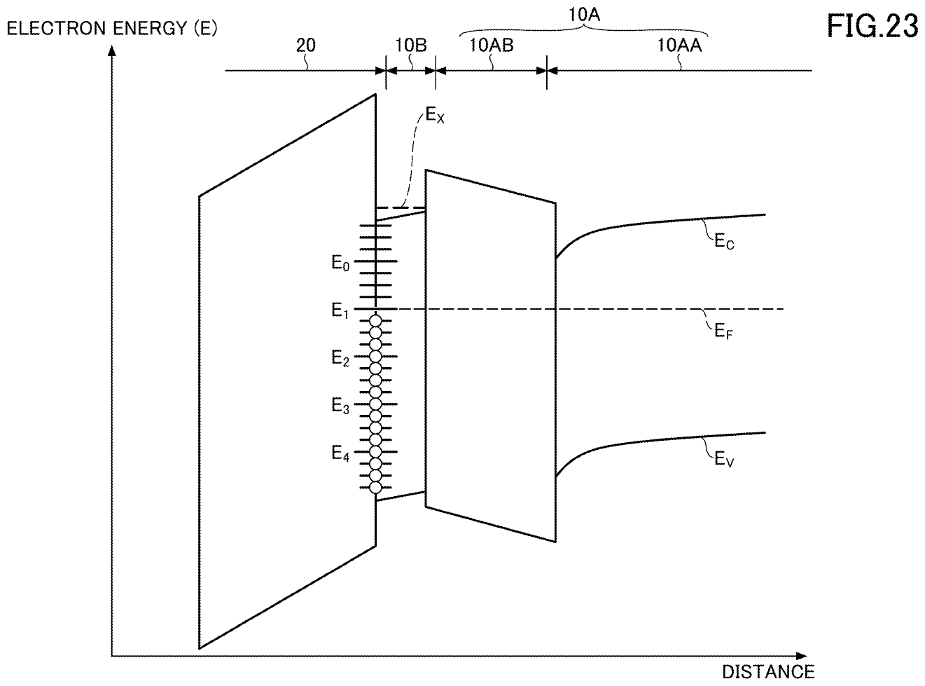

FIG. 23 is a band diagram illustrating potential distribution in a laminated structure used in the simulation method according to the second embodiment;

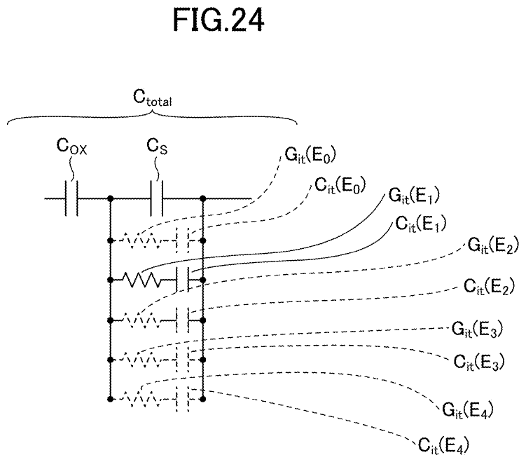

FIG. 24 is a diagram illustrating an equivalent circuit of the band structure illustrated in FIG. 23;

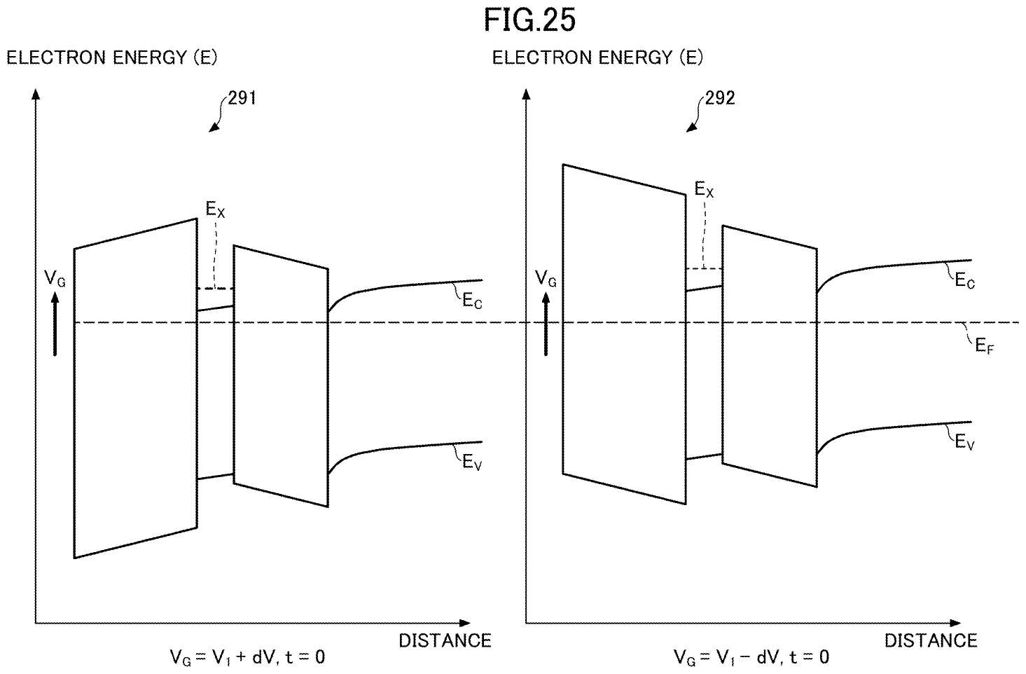

FIG. 25 is a diagram illustrating first potential distribution and second potential distribution in the first embodiment, arranged side by side;

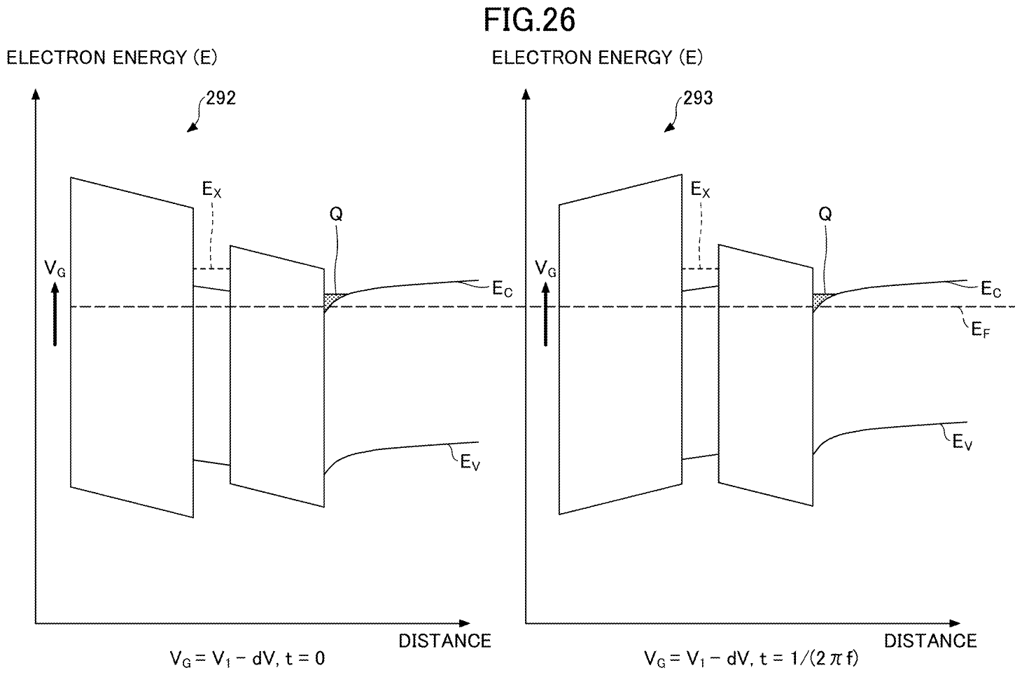

FIG. 26 is a diagram illustrating the second potential distribution and third potential distribution in the first embodiment, arranged side by side;

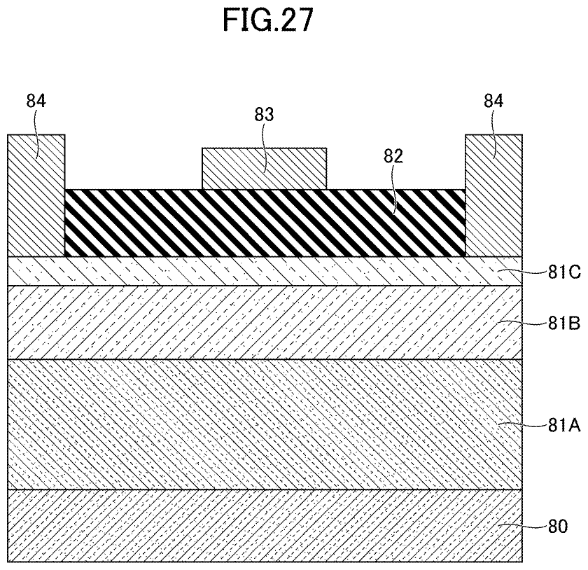

FIG. 27 is a cross-sectional view illustrating a laminated structure of the object of the simulation related to the second embodiment;

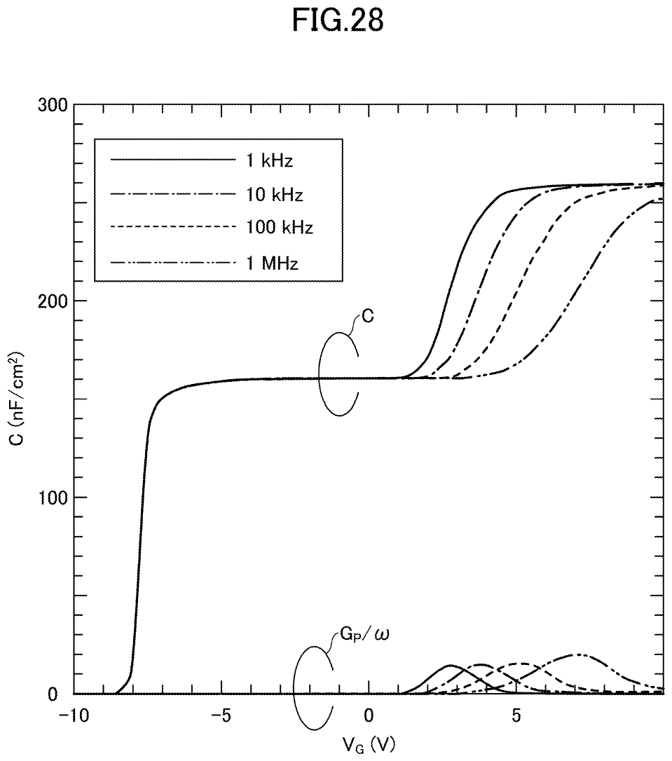

FIG. 28 is a graph illustrating a simulation result of the laminated structure illustrated in FIG. 27;

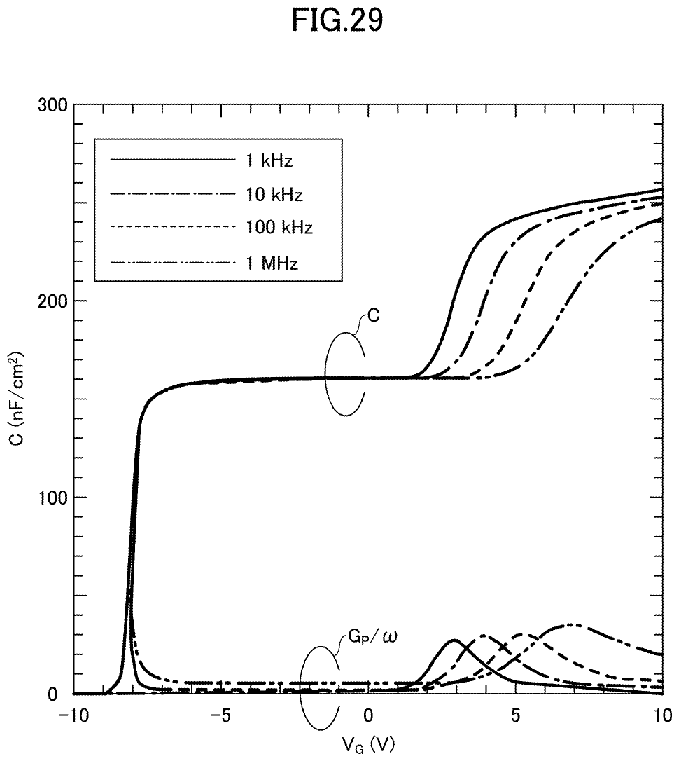

FIG. 29 is a graph illustrating an actual measurement result of the laminated structure illustrated in FIG. 27; and

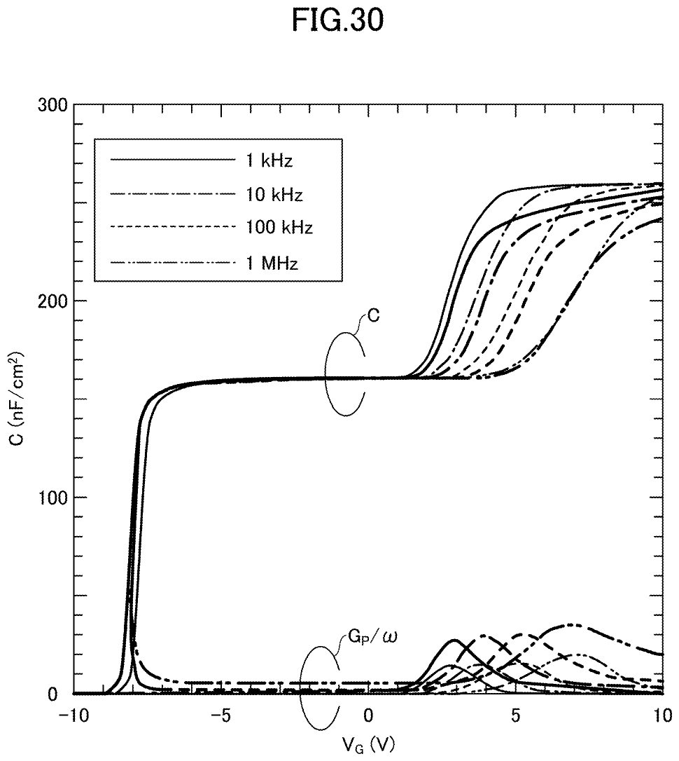

FIG. 30 is a graph illustrating the simulation result and the actual measurement result, overlapping with each other, related to the first embodiment.

### DESCRIPTION OF THE EMBODIMENTS

Embodiments will be described below.

[Description of the Embodiments of the Present Disclosure]

A list of the embodiments of the present disclosure will first be described. In the following description, the same or corresponding elements are referenced by the same signs and the description about the same or corresponding elements is not repeated. At least some of the embodiments described below may be combined as desired.

[1] A simulation method according to one aspect of the present disclosure is a method of simulating a capacitance-voltage (C-V) characteristic of a laminated structure including a semiconductor, an insulator provided on the semiconductor, and a metal provided on the insulator. The method uses a model of the C-V characteristic of the laminated structure that includes multiple discrete interface states, at which electrons are trapped or emitted in response to a change of a voltage applied to the metal, at an interface between the semiconductor and the insulator. The model of the C-V characteristic represents a third capacitance in response to the change of the voltage, the third capacitance including a first capacitance of a depletion layer formed at the interface, a second capacitance of the multiple discrete interface states, and a capacitance of the insulator. The first capacitance and the second capacitance are connected in parallel, and the capacitance of the insulator is connected in series with the first capacitance and the second capacitance connected in parallel. The method includes calculating the first capacitance in accordance with a first voltage applied to the metal, and calculating the second capacitance from a quantity of electrons emitted from a first interface state corresponding to the first voltage among the multiple discrete interface states. The calculating of the second capacitance includes changing the first voltage in stages and shifting the first interface state in stages.

In the model of the C-V characteristic that includes the multiple discrete interface states at the interface between the semiconductor and the insulator, the second capacitance of the multiple discrete interface states is calculated independently of the first capacitance of the semiconductor, and the capacitance of the laminated structure is calculated using the first capacitance and the second capacitance of the multiple discrete interface states. According to this method, the C-V characteristic of the laminated structure can be accurately obtained.

[2] In [1], a time constant for each of the multiple discrete interface states may be used to calculate the third capacitance. In this case, a more accurate simulation can be performed.

[3] In [1] or [2], the calculating of the first capacitance may include calculating a first electron quantity in the semiconductor from a first potential distribution formed when a second voltage higher than the first voltage is applied to the metal and electrons are trapped at at least one of the multiple interface states, calculating a second electron quantity in the semiconductor from a second potential distribution formed when a third voltage lower than the first voltage is applied to the metal while the electrons are trapped at the at least one of the multiple interface states, and dividing a difference between the first electron quantity and the second electron quantity by a difference between the second voltage and the third voltage. In this case, the first capacitance can be obtained with higher accuracy by using the first potential distribution and the second potential distribution.

[4] In [3], the second capacitance may be calculated from a third potential distribution formed when a predetermined time elapses from the time when the second potential distribution is formed and the electrons are emitted from the at least one of the multiple interface states. In this case, the second capacitance can be obtained with higher accuracy by using the third potential distribution.

[5] In [3] or [4], the difference between the second voltage and the first voltage may be equal to the difference between the first voltage and the third voltage. In this case, it is easier to calculate the first capacitance and the second capacitance.

[6] In [1] to [5], a step of setting multiple frequencies of AC signals applied to the metal and a step of calculating the C-V characteristic of the laminated structure for each of the multiple frequencies based on a relation between the first voltage and the third capacitance may be included. In this case, the frequency dependence of the C-V characteristic, that is, the frequency dispersion can be analyzed.

[7] In [1] to [6], the semiconductor may include a first semiconductor having a first band gap and a second semiconductor having a second band gap smaller than the first band gap of the first semiconductor, the insulator may be disposed on the second semiconductor, a model of the C-V characteristic of the laminated structure may include a quantum well of the second semiconductor between the first semiconductor and the insulator, and the second capacitance may be calculated from the quantity of electrons emitted into the quantum well from the first interface state corresponding to the first voltage among the multiple discrete interface states. In this case, the frequency dependence of the C-V characteristic in HEMT is easily analyzed.

[8] A program according to another aspect of the disclosure is a program for causing a computer to perform a process of simulating a C-V characteristic of a laminated structure including a semiconductor, an insulator provided on the semiconductor, and a metal provided on the insulator. The process uses a model of the C-V characteristic of the laminated structure that includes multiple discrete interface states, at which electrons are trapped or emitted in response to a change of a voltage applied to the metal, at an interface between the semiconductor and the insulator. The model of the C-V characteristic represents a third capacitance in response to the change of the voltage, the third capacitance including a first capacitance of a depletion layer formed at the interface, a second capacitance of the multiple discrete interface states, and a capacitance of the insulator. The first capacitance and the second capacitance are connected in parallel, and the capacitance of the insulator is connected in series with the first capacitance and the second capacitance connected in parallel. The process includes calculating the first capacitance in accordance with a first voltage applied to the metal, calculating the second capacitance from a quantity of electrons emitted from a first interface state corresponding to the first voltage among the multiple discrete interface states, calculating the third capacitance, and changing the first voltage in stages and shifting the first interface state.

[9] A simulation device according to another aspect of the present disclosure is a device of simulating a C-V characteristic of a laminated structure including a semiconductor, an insulator provided on the semiconductor, and a metal provided on the insulator, by using a model of the C-V characteristic of the laminated structure that includes multiple discrete interface states, at which electrons are trapped or emitted in response to a change of a voltage applied to the metal, at an interface between the semiconductor and the insulator. The model of the C-V characteristic represents a third capacitance in response to the change of the voltage, the third capacitance including a first capacitance of a depletion layer formed at the interface, a second capacitance of the multiple discrete interface states, and a capacitance of the insulator. The first capacitance and the second capacitance are connected in parallel, and the capacitance of the insulator is connected in series with the first capacitance and the second capacitance connected in parallel. The device includes a processor, and a memory storing program instructions that cause the processor to calculate the first capacitance in accordance with a first voltage applied to the metal, calculate the second capacitance from a quantity of electrons emitted from a first interface state corresponding to the first voltage among the multiple discrete interface states, and calculate the third capacitance. The processor changes the first voltage in stages and shifting the first interface state in stages and calculates a total capacitance value from the first capacitance, the second capacitance calculated for each changed first voltage, and the capacitance of the insulator.

### First Embodiment

The first embodiment relates to a method of simulating a characteristic of a laminated structure including a semiconductor, an insulator, and a metal. FIG. 1 is a cross-sectional view illustrating an object of the simulation method according to the first embodiment. As illustrated in FIG. 1, the object of the simulation method according to the first embodiment is a laminated structure 101 including a semiconductor 10, an insulator 20 provided on the semiconductor 10, and a metal 30 provided on the insulator 20. That is, the laminated structure 101 has a metal-insulator-semiconductor (MIS) structure. For example, the semiconductor 10 may be n-type GaN or AlGaN, and the insulator 20 may be SiN or Al₂O₃.

FIG. 2 is a band diagram illustrating ideal potential distribution in the object of the simulation method according to the first embodiment. In FIG. 2, the vertical axis indicates the magnitude of the electron energy, and the horizontal axis corresponds to the cross-sectional view of FIG. 1 and represents a distance in a direction perpendicular to the interface between the insulator 20 and the semiconductor 10 and in a direction from the insulator 20 toward the semiconductor 10. E_{V} represents the top of the highest energy band occupied by electrons in the band structure (i.e., the valence band). E_{C} represents the bottom of the lowest empty energy band (i.e., a conduction band) in the band structure. E_{F} represents the Fermi level. In the example of FIG. 2, the semiconductor 10 is an n-type semiconductor, a state in which a bias voltage V_{G} is applied to the metal 30, which is not illustrated in FIG. 2 (see FIG. 1), is illustrated.

In the laminated structure 101, there is a depletion layer 40 near the interface between the semiconductor 10 and the insulator 20, and the thickness of the depletion layer 40 changes in a direction perpendicular to the interface, in accordance with the voltage applied to the metal 30. As illustrated in FIG. 2, there is an electron e in a portion of the semiconductor 10 that is away from the insulator 20 over the depletion layer 40. As the thickness of the depletion layer 40 changes, the capacitance and the quantity of electrons between the semiconductor 10 and the metal 30 change.

Actually, although not illustrated in FIG. 2, there is an interface state at the interface between the semiconductor 10 and the insulator 20. In the interface state, when the voltage is applied to the metal 30, electrons are trapped or emitted in accordance with the magnitude of the energy E of the interface state. For example, when a small AC bias voltage that is a small AC voltage superimposed on a DC bias voltage is applied to the metal 30, the quantity of electrons in the semiconductor 10 changes and the trap or emission of electrons occurs at the interface state.

FIG. 3 is a band diagram illustrating potential distribution in consideration of the interface state in the laminated structure 101. As illustrated in FIG. 3, the interface between the semiconductor 10 and the insulator 20 includes multiple interface states 50. In FIG. 3, the multiple interface states 50 are illustrated discretely, for the purpose of convenience, but actually the multiple interface states 50 continuously exist. FIG. 3 illustrates an example in which some electrons 51 are emitted from an interface state having greater energy than the Fermi level E_{F}, and the electrons 52 remain trapped at the interface state near the Fermi level E_{F} or at the interface states having less energy than Fermi level E_{F}.

FIG. 4 is a diagram illustrating an equivalent circuit of the band structure illustrated in FIG. 3. Capacitance Cₒₓ represents the insulator capacitance formed in accordance with the thickness and permittivity of the insulator 20, and capacitance C_{S} represents the depletion capacitance C_{S} formed in accordance with the thickness of the depletion layer 40 according to the impurity concentration of the semiconductor 10 and the applied bias V_{G}. The capacitance Cₒₓ and the depletion capacitance C_{S} can be represented in the equivalent circuit as being connected in series with each other, as illustrated in FIG. 4. Capacitance Cᵢₜ represents capacitance formed in accordance with the state in which electrons are trapped or emitted at the interface states 50, conductance Gᵢₜ represents a time constant τ of electrons trapped or emitted at the interface states 50, and the time constant τ is defined by τ=Cᵢₜ/Gᵢₜ with the capacitance Cᵢₜ.

The capacitance Cᵢₜ and the conductance Gᵢₜ can be represented in the equivalent circuit as being connected in series with each other and connected in parallel with the depletion capacitance C_{S}, as illustrated in FIG. 4. The equivalent circuit for the capacitance Cₜₒₜₐₗ as an entirety of the laminated structure 101 can be represented as the capacitance Cₒₓ, the depletion capacitance C_{S}, the capacitance Cᵢₜ, and conductance Gᵢₜ being connected as illustrated in FIG. 4.

The equations representing the capacitance Cₜₒₜₐₗ of the entirety of the laminated structure 101 derived from the equivalent circuit of FIG. 4 are expressed as Eq. 1 to Eq. 5. Here, f in Eq. 5 represents a small amplitude variation frequency f of the applied bias V_{G}. In the conventional C-V characteristic simulation method, when the frequency f is as low as 1 Hz to 1 kHz, the reproducibility of the capacitance Cᵢₜ formed in accordance with the interface states is insufficient, and the accuracy of the capacitance Cₜₒₜₐₗ of the entirety of the laminated structure 101 is low.

$$\begin{matrix}[ Eq . 1 ] & \\ {C}_{total} = {C}_{OX} \frac{{( \frac{{G}_{P}}{ω} )}^{2} + ( {C}_{S} + \frac{{C}_{it}}{1 + {ω}^{2} {τ}^{2}} ) ( {C}_{OX} + {C}_{S} + \frac{{C}_{it}}{1 + {ω}^{2} {τ}^{2}} )}{{( \frac{{G}_{P}}{ω} )}^{2} + {( {C}_{OX} + {C}_{S} + \frac{{C}_{it}}{1 + {ω}^{2} {τ}^{2}} )}^{2}} & ( 1 ) \\ [ Eq . 2 ] & \\ G = {G}_{P} \frac{{C}_{OX}^{2}}{{( \frac{{G}_{P}}{ω} )}^{2} + {( {C}_{OX} + {C}_{S} + \frac{{C}_{it}}{1 + {ω}^{2} {τ}^{2}} )}^{2}} & ( 2 ) \\ [ Eq . 3 ] & \\ \frac{{G}_{P}}{ω} = \frac{ω {C}_{it} τ}{1 + {ω}^{2} {τ}^{2}} & ( 3 ) \\ [ Eq . 4 ] & \\ τ = \frac{{C}_{it}}{{G}_{it}} & ( 4 ) \\ [ Eq . 5 ] & \\ ω = 2 π f & ( 5 )\end{matrix}$$

In the first embodiment, a C-V characteristic model (hereinafter, referred to as the model) including multiple discrete interface states is used for the laminated structure 101. FIG. 5 is a band diagram illustrating potential distribution of the laminated structure 101 that is used in the simulation method according to the first embodiment. FIG. 6 is a diagram illustrating an equivalent circuit of the band structure illustrated in FIG. 5. The band diagram of FIG. 5 has multiple discrete interface states in comparison with the band diagram of FIG. 3. The example illustrated in FIG. 5 has five discrete interface states E₀, E₁, E₂, E₃, and E₄ from higher energy.

The equivalent circuit illustrated in FIG. 6 has capacitance Cᵢₜ(Eₖ) and conductance Gᵢₜ(Eₖ) of multiple interface states, connected in parallel, corresponding to multiple discrete interface states Eₖ in comparison with the equivalent circuit illustrated in FIG. 4. Here, k is an integer greater than or equal to 0, and as the value of k increases, the interface state Eₖ becomes deeper (i.e., the electron energy becomes lower). The example of FIG. 6 corresponds to five discrete interface states E0, E1, E2, E3, and E4, and has capacitance Cᵢₜ(E₀), Gᵢₜ(E₁), Cᵢₜ(E₂), Cᵢₜ(E₃) Gᵢₜ(E₄) and conductance Gᵢₜ(E₀), Gᵢₜ(E₁), Gᵢₜ(E₂), Gᵢₜ(E₃), and Gᵢₜ(E₄) of five interface states connected in parallel to the depletion capacitance C_{S}. Each conductance Gᵢₜ(Eₖ) represents the time constant τ (Eₖ) at which electrons are trapped or emitted from a corresponding discrete interface state and is defined by τ(Eₖ)=Cᵢₜ(Eₖ)/ Gᵢₜ(Eₖ). The equations representing the capacitance Cₜₒₜₐₗ of the entirety of the laminated structure 101 derived from the equivalent circuit illustrated in FIG. 6 are represented as Eq. 6 to Eq. 9.

$$\begin{matrix}[ Eq . 6 ] & \\ {C}_{total} = {C}_{OX} \frac{\begin{matrix}{( \frac{{G}_{P}}{ω} )}^{2} + \\ ( {C}_{S} + {\sum }_{k = 0}^{n} \frac{{C}_{it} ( {E}_{k} )}{1 + {ω}^{2} {τ ( {E}_{k} )}^{2}} ) ( {C}_{OX} + {C}_{S} + {\sum }_{k = 0}^{n} \frac{{C}_{it} ( {E}_{k} )}{1 + {ω}^{2} {τ ( {E}_{k} )}^{2}} )\end{matrix}}{{( \frac{{G}_{P}}{ω} )}^{2} + {( {C}_{OX} + {C}_{S} + {\sum }_{k = 0}^{n} \frac{{C}_{irt} ( {E}_{k} )}{1 + {ω}^{2} {τ ( {E}_{k} )}^{2}} )}^{2}} & ( 6 ) \\ [ Eq . 7 ] & \\ \frac{{G}_{P}}{ω} = {\sum }_{k = 0}^{n} \frac{ω {C}_{it} ( {E}_{k} ) τ ( {E}_{k} )}{1 + {ω}^{2} {τ ( {E}_{k} )}^{2}} & ( 7 ) \\ [ Eq . 8 ] & \\ τ ( {E}_{k} ) = \frac{{C}_{it} ( {E}_{k} )}{{G}_{it} ( {E}_{k} )} & ( 8 ) \\ [ Eq . 9 ] & \\ ω = 2 π f & ( 9 )\end{matrix}$$

In the first embodiment, the capacitance C_{S} of the semiconductor 10 that is formed when a first voltage, for example, the above-described DC bias voltage V_{G}, is applied to the metal 30 is obtained using the model illustrated in FIG. 5 and FIG. 6, and the corresponding model equations of Eq. 6 to Eq. 9 to calculate the capacitance Cᵢₜ(Eₖ) of the multiple discrete interface states that is formed when the first voltage is applied to the metal 30 for each of the multiple discrete interface states Eₖ. The capacitance Cᵢₜ(Eₖ) is calculated from the quantity of electrons emitted from the capacitance Cᵢₜ(Eₖ) of each of the multiple discrete interface states when the voltage applied to the metal 30 changes.

Subsequently, the capacitance Cₜₒₜₐₗ of the laminated structure 101 that is formed when the first voltage is applied to the metal 30 is calculated using the capacitance Cₒₓ, the capacitance C_{S}, and the capacitance Cᵢₜ(Eₖ) for each of the multiple discrete interface states Eₖ.

As described, in this simulation method, the capacitance Cᵢₜ(Eₖ) for each of the multiple discrete interface states Eₖ is calculated independently of the capacitance C_{S}. According to the simulation method, the capacitance Cₜₒₜₐₗ of the laminated structure 101 at the first voltage can be calculated with high accuracy.

The C-V characteristic can be obtained with high accuracy by changing the first voltage in stages and calculating the capacitance Cᵢₜ(Eₖ) of the interface state Eₖ corresponding to the first voltage, for each changed first voltage.

Further, by setting multiple frequencies of AC signals applied to the metal 30 and obtaining the C-V characteristic for each of the frequencies, the frequency dependence of the C-V characteristic, that is, the frequency dispersion of the C-V characteristic can be analyzed.

FIGS. 7 to 12 are diagrams illustrating an operation of calculating the capacitance Cᵢₜ(Eₖ) for each individual interface state Eₖ. FIG. 7 and FIG. 8 illustrate a state in which electrons, trapped at a corresponding interface state, are emitted when the bias V_{G}, applied to the metal 30 corresponding to the gate electrode of the transistor, is changed. FIG. 7 is a band diagram illustrating a state in which the first discrete interface state E₀ (k=0) is raised to a position equivalent to the Fermi level E_{F} by the bias V_{G} (V_{G}=V₀−dV) applied to the metal 30. FIG. 8 is a band diagram illustrating a state in which the next discrete interface state E₁ (k=1) is raised to a position equivalent to the Fermi level E_{F} by the bias V_{G} (V_{G}=V₁−dV) applied to the metal 30. FIG. 8 illustrates a state in which electrons, trapped at interface states between the discrete interface state E₁ and the discrete interface state E₀ in the state illustrated in FIG. 7, are emitted.

In each of FIGS. 7 to 12, the definition t=1/(2πf) is used from Eq. 9. As with Eq. 5, f in Eq. 9 represents the small amplitude variation frequency f of the applied bias voltage V_{G}. As will be described later, in order to determine the depletion capacitance C_{S} and the capacitance Cᵢₜ(Eₖ) of the discrete interface state Eₖ, a small amplitude bias variation dV is supplied for the applied DC bias. Here, a variation frequency of the small amplitude bias variation dV is f. Because it is assumed that the emission of electrons trapped at the discrete interface states Eₖ follows changes in small bias variation dV, the period of the frequency f is, of course, adapted to be greater than the time constant defined in Eq. 8.

As illustrated in FIG. 7 and FIG. 8, the multiple interface states themselves are continuously present, and a large number of electrons are trapped at the multiple interface states. However, in the model of the present embodiment, multiple interface states are represented as being discretely present. In other words, the multiple interface states are represented using several discrete interface states Eₖ as being representatives. Specifically, as is obvious from a comparison between FIG. 7 and FIG. 8 for example, electrons trapped between the discrete interface state E₀ (k=0) and the discrete interface state E₁ (k=1) are represented as if the electrons had been trapped at the discrete interface state E₁ (k=1). Equation (10) represents this situation.

$$[ Eq . 10 ]$$

$${C}_{it} ( {E}_{k} ) = \frac{Δ {Q}_{it} ( {E}_{k} )}{Δ V} \qquad ( 10 )$$

Eq. 10 will be explained with reference to FIG. 7 and FIG. 8. ΔV represents the difference between two applied biases, where ΔV=V₁−V₂. Each applied bias is considered to be, with respect to a given discrete interface state Eₖ, an applied bias necessary to cause electrons trapped at the given discrete interface state Eₖ to be emitted. In FIG. 7 and FIG. 8, by applying a bias having the ΔV difference, a change from the state of the band diagram of FIG. 7 to the state of the band diagram of FIG. 8 is caused. As a result of the change of the state, the electrons trapped between the discrete interface state E₁ and the discrete interface states E₀ are emitted. The quantity of electrons emitted is defined as an increased electron quantity ΔQᵢₜ (Eₖ) (here, k=1). The increased electron quantity ΔQᵢₜ (Eₖ) (k=1) is defined as the capacitance Cᵢₜ(E₁) (k=1) of the interface state, as being stored at the representative discrete interface state E₁ (k=1). These relationships are shown in Eq. 10.

FIGS. 9 to 12 are diagrams illustrating the equivalent circuit described in association with the changes in the potential distribution of the band diagrams of FIG. 7 and FIG. 8, by respectively associating the discrete interface states of interest with the circuit diagrams.

FIG. 9 is a band diagram illustrating a state in which the discrete interface state E₁ (k=1) is raised to a position equivalent to the Fermi level E_{F} by the bias voltage V_{G} (V_{G}=V₁−dV) applied to the metal 30. FIG. 9 illustrates a state the same as the state of FIG. 8. FIG. 10 is a diagram illustrating an equivalent circuit of the band structure illustrated in FIG. 9. FIG. 10 illustrates the capacitance Cᵢₜ(E₁) and the conductance Gᵢₜ(E₁) of the interface state.

FIG. 11 is a band diagram illustrating a state in which the discrete interface state E₂ (k=2) is raised to a position equivalent to the Fermi level E_{F} by the bias voltage V_{G} (V_{G}=V₂−dV) applied to the metal 30. FIG. 11 illustrates a state in which electrons trapped between the discrete interface state E2 and the discrete interface state E1 are emitted as a result of the application of the bias voltage, which leads to the state of FIG. 9. FIG. 12 is a diagram illustrating an equivalent circuit of the band structure illustrated in FIG. 11. FIG. 12 illustrates the capacitance Cᵢₜ(E₂) and the conductance Gᵢₜ(E₂) of the interface state in addition to the capacitance Cᵢₜ(E₁) and the conductance Gᵢₜ(E₁) in FIG. 10.

Next, a simulation device suitable for performing the above-described simulation method will be described. FIG. 13 is a diagram illustrating a hardware configuration of the simulation device. In FIG. 13, the simulation device 100 is an information processing device controlled by a computer and includes a central processing unit (CPU) 11, a main storage device 12, an auxiliary storage device 13, an input device 14, a display device 15, a communication interface (I/F) 17, and a drive device 18, which are connected to a bus B.

The CPU 11 corresponds to a processor that controls the simulation device 100 according to a program stored in the main storage device 12. The main storage device 12 may be a random access memory (RAM), a read only memory (ROM), or the like, and store or temporarily store a program executed by the CPU 11, data necessary for processing of the CPU 11, data obtained by processing of the CPU 11, or the like.

The auxiliary storage device 13 may be a hard disk drive (HDD) or the like, and store data such as a program for executing various processes. When a portion of the program stored in the auxiliary storage device 13 is loaded into the main storage device 12 and executed by the CPU 11, various processes are achieved. A storage unit 130 includes the main storage device 12 and the auxiliary storage device 13.

The input device 14 includes a mouse, a keyboard, or the like, and is used by a user to input various information required for processing of the simulation device 100. The display device 15 displays various necessary information under the control of the CPU 11. The input device 14 and the display device 15 may be a user interface, such as an integrated touch panel. The communication I/F 17 communicates over a network, such as wired or wireless communication. The communication through the communication I/F 17 is not limited to wired or wireless communication.

A program that implements the processes performed by the simulation device 100 is provided to the simulation device 100 by a storage medium 19, such as a compact disk read-only memory (CD-ROM).

The drive device 18 interfaces the storage medium 19 (e.g., a CD-ROM) set in the drive device 18 with the simulation device 100.

A program that implements various processes according to the present embodiment, which will be described later, is stored in the storage medium 19, and the program stored in the storage medium 19 is installed in the simulation device 100 through the drive device 18. The installed program can be executed by the simulation device 100.

The storage medium in which the program is stored is not limited to the CD-ROM. As a computer-readable storage medium, in addition to the CD-ROM, a portable storage medium, such as a digital versatile disk (DVD), a universal serial bus (USB) memory, or a semiconductor memory such as a flash memory may be used.

FIG. 14 is a diagram illustrating a functional configuration of the simulation device. In FIG. 14, the simulation device 100 mainly includes an input data obtaining unit 41 and a simulation executing unit 42. The input data obtaining unit 41 and the simulation executing unit 42 are achieved by the program installed in the simulation device 100 causing the CPU 11 of the simulation device 100 to perform the processes. The storage unit 130 stores a mathematical expression or the like for calculating potential distribution in the simulation.

The input data obtaining unit 41 obtains data to be input to the simulation executing unit 42. The input data obtaining unit 41 obtains, for example, parameters related to the laminated structure 101 to be simulated from an input of a user.

The simulation executing unit 42 reads the data input to the input data obtaining unit 41 and executes the simulation. The simulation executing unit 42 includes a model equation obtaining unit 43, a C_{S} calculating unit 44, a Cᵢₜ(Eₖ) calculating unit 45, and a Cₜₒₜₐₗ calculating unit 46.

The model equation obtaining unit 43 generates and obtains model equations (Eq. 6 to Eq. 9) related to the model including multiple discrete interface states Eₖ at the interface between the semiconductor 10 and the insulator 20 from the equivalent circuit illustrated in FIG. 6 by using the parameters related to the laminated structure 101 that are input to the input data obtaining unit 41.

The C_{S} calculating unit 44 calculates the capacitance C_{S} of the semiconductor 10 that is formed when the first voltage is applied to the metal 30 by using the model equations generated and obtained by the model equation obtaining unit 43. The C_{S} calculating unit 44 calculates the capacitance C_{S} by using the parameters related to the laminated structure 101 that is input to the input data obtaining unit 41. The C_{S} calculating unit 44 is an example of a first capacitance calculating unit.

The Cᵢₜ(Eₖ) calculating unit 45 calculates the capacitance Cᵢₜ(Eₖ) of a given discrete interface state Eₖ that is formed when the first voltage is applied to the metal 30 from the quantity of electrons emitted from the given discrete interface state Eₖ when the voltage applied to the metal 30 changes, by using the model equations obtained by the model equation obtaining unit 43, for each of the multiple discrete interface states Eₖ. The Cᵢₜ(Eₖ) calculating unit 45 is an example of a second capacitance calculating unit.

The Cₜₒₜₐₗ calculating unit 46 calculates the capacitance Cₜₒₜₐₗ of the laminated structure 101 that is famed when the first voltage is applied to the metal 30 by using the capacitance C_{S} and the capacitance Cᵢₜ(Eₖ) for each of the multiple discrete interface states Eₖ, by using the model equations generated by the model equation obtaining unit 43. The Cₜₒₜₐₗ calculating unit 46 is an example of a third capacitance calculating unit.

Next, the processes performed by the simulation device 100 will be described. FIG. 15 is a flowchart illustrating the simulation method performed by the simulation device. This simulation method performs a simulation of the C-V characteristic based on changes in the quantity of electrons observed when a small DC bias, in which a small AC voltage is superimposed on a DC bias, is applied to the metal 30.

As illustrated in FIG. 15, first, in step S101, the input data obtaining unit 41 obtains the parameters related to the laminated structure 101. The parameters include, for example, a material, permittivity, thickness, and donor density of the semiconductor 10, and a material, permittivity, and thickness of the insulator 20. The parameters also include the frequency of the signal applied to the metal 30, the range of the first voltage (i.e., the DC bias), the magnitude of the change in the first voltage (Vₛₜₑₚ), and the amplitude of the small AC voltage (dV) to be simulated. Here, the following description assumes that the frequency of the signal and the small AC voltage applied to the metal 30 is f, the range of the first voltage is from −10 V to +10 V, the first voltage changes by 0.1 V in stages, and the amplitude of the small AC voltage is 10 mV.

Next, in Step S102, the model equation obtaining unit 43 generates and obtains the model equation of the model including multiple discrete interface states Eₖ at the interface between the semiconductor 10 and the insulator 20 by using information such as the materials of the semiconductor 10 and the insulator 20.

In step S103, the minimum value of the range of the first voltage (i.e., −10 V) is set as an initial value V₀ of the first voltage V, and the C_{S} calculating unit 44 calculates first potential distribution formed when the voltage V_{G} of the metal 30 is a second voltage (V+dV) that is higher than the first voltage by dV and electrons are trapped at at least one of the discrete interface states Eₖ. In step S104, an electron quantity Q1 in the semiconductor 10 is calculated from the first potential distribution.

Next, the C_{S} calculating unit 44 calculates the second potential distribution formed when the voltage V_{G} of the metal 30 is a third voltage (V−dV) that is lower than the first voltage by dV while electrons are trapped at at least one of the discrete interface states Eₖ. In step S105, an electron quantity Q2 in the semiconductor 10 is calculated from the second potential distribution.

FIG. 16 is a band diagram illustrating first potential distribution 191 formed when the second voltage is applied to the metal 30 and second potential distribution 192 formed when the third voltage is applied to the metal 30, arranged side by side. As illustrated in FIG. 16, in the first embodiment, when the first potential distribution 191 is compared with the second potential distribution 192, the electron energy of the third voltage applied to the metal 30 is higher than the electron energy of the second voltage. As a result, the thickness of the depletion layer 40 increases in the second potential distribution 192 (i.e., the right side of FIG. 16) in comparison with the first potential distribution 191 (i.e., the left side of FIG. 16). Thus, the capacitance C_{S} of the semiconductor 10 is reduced and the electron quantity Q2 of the semiconductor 10 in the second potential distribution is less than the electron quantity Q1 of the semiconductor 10 in the first potential distribution.

In step S120, the C_{S} calculating unit 44 calculates the capacitance Cₒₓ of the insulator 20 after obtaining the model equation in step S102. In step S106, the C_{S} calculating unit 44 calculates the capacitance C_{S} of the semiconductor 10 by using the difference ΔQ (=Q1−Q2) of the electron quantity in the semiconductor 10 between the first potential distribution 191 and the second potential distribution 192, the difference ΔV (=2dV) between the second voltage and the third voltage, and the capacitance Cₒₓ of the insulator 20 after calculating the second potential distribution in step S105. Here, the present embodiment assumes that time change is not considered. That is, step S104 and step S105 in the flowchart of FIG. 15 are performed, for example, at a moment of t=0. Specifically, it is assumed that, at a moment of t=0, the application of the second voltage and the formation of the first potential distribution 191 are immediately performed, as illustrated on the left side of FIG. 16, and the application of the third voltage and the formation of the second potential distribution 192 are immediately performed, as illustrated on the right side of FIG. 16.

As a result, in step S106, the C_{S} calculating unit 44 calculates the capacitance C_{S} without considering the emission of electrons from the discrete interface state Eₖ. That is, the C_{S} calculating unit 44 calculates the capacitance C_{S} by assuming that a state in which electrons are trapped at the discrete interface state Eₖ is maintained. This is equivalent to assuming that, in Eq. 6 to Eq. 8, the time t is 0 that is less than the time constant τ(Eₖ), and Cᵢₜ(Eₖ)=0.

Next, the Cᵢₜ(Eₖ) calculating unit 45 calculates third potential distribution 193 formed when the voltage V_{G} of the metal 30 is the third voltage (V−dV) and the time is t=1/(2πf). In step S107, an electron quantity Q3 in the semiconductor 10 is calculated from the third potential distribution 193. Here, the time t is defined by setting the time, at step S104 and step S105, at which the first potential distribution 191 and the second potential distribution 192 are obtained, as t=0, and the time t is, for example, 1/(2πf) that is larger than the time constant τ(Eₖ). FIG. 9 illustrates an example of the third potential distribution 193. The condition of the example of the third potential distribution 193 illustrated in FIG. 9 is “V_{G}=V1−dV, t=1/(2πf)”. That is, FIG. 9 illustrates the third potential distribution 193, calculated in step S107 following step S105, illustrated on the right side of FIG. 16 in the condition of “V_{G}=V1−dV, t=0”.

Next, in step S108, the Cᵢₜ(Eₖ) calculating unit 45 compares the second potential distribution 192 with the third potential distribution 193, calculates an electron quantity ΔQᵢₜ(Eₖ) of electrons emitted from each discrete interface state Eₖ during a time period Δt, and calculates the capacitance Cᵢₜ(Eₖ) for each discrete interface state Eₖ. For example, in the example illustrated in FIG. 9 and FIG. 10, with respect to the discrete interface state E₁ where k=1, the capacitance Cᵢₜ(E₁) is calculated. As also illustrated in FIG. 8 as a change from FIG. 7, by applying the third voltage, continuous interface states between the discrete interface state E₀ and the discrete interface state E₁ are raised to an energy equivalent to the Fermi level E_{F} or higher than the Fermi level E_{F}, and electrons trapped at the continuous interface states between the discrete interface state E₀ and the discrete interface state E₁ are emitted to the bottom edge of the conduction band, as indicated by the arrows in FIG. 8 and FIG. 9. Additionally, electrons trapped at interface states that are lower in energy than the discrete interface states E₁ remain trapped at the interface states because the energy is lower than the Fermi level E_{F}.

In the calculation of each capacitance Cᵢₜ(Eₖ), the electron quantity ΔQᵢₜ(Eₖ) of electrons emitted from each discrete interface state Eₖ and the difference ΔV (=2dV) between the second voltage and the third voltage are used. The relationship of Eq. 10 is established between ΔQᵢₜ(Eₖ), ΔV, and Cᵢₜ(Eₖ). For example, the capacitance Cᵢₜ(E₁) and the conductance Gᵢₜ(E₁) in the diagram of the equivalent circuit as illustrated in FIG. 10 can be determined. In the present embodiment, when calculating the conductance Gᵢₜ(Eₖ), the conductance Gᵢₜ(Eₖ) can be easily calculated by substituting τ (Eₖ) calculated from the model equation (11) of the Shockley-Read-Hall (SRH) model into Eq. 8.

$$[ Eq . 11 ]$$

$$τ ( {E}_{k} ) = \frac{1}{{N}_{C} v σ ( {E}_{k} )} exp ( \frac{{E}_{C} - {E}_{k}}{kT} ) \qquad ( 11 )$$

In the present embodiment, in Eq. 11, τ (E₁) is simply calculated by substituting the discrete interfacial state E₁ as the value of energy E. As illustrated in FIG. 9, multiple and continuous interface states are actually present, but in the present embodiment, for example, all electrons trapped in the continuous interface states between the discrete interface state E₀ and the discrete interface state E₁ are considered to be present at the discrete interface state E₁, and the time constant at which the trapped electrons are emitted is uniquely defined as τ (E₁). As a result, the value of the model equation (11) can be substituted into Eq. 8.

Next, in step S109, the Cₜₒₜₐₗ calculating unit 46 calculates the capacitance Cₜₒₜₐₗ of the laminated structure 101 by using the capacitance C_{S} and the capacitance Cᵢₜ(Eₖ) for each of the multiple discrete interface states Eₖ. For example, as illustrated in FIG. 11 and FIG. 12, after determining the capacitance Cᵢₜ(E₂) and the conductance Gᵢₜ(E₂) as V_{G}=V₂−dV for the discrete interface states E₂ (step S108), the capacitance Cᵢₜ(E₂) and the conductance Gᵢₜ(E₂) are added in parallel to the capacitance Cᵢₜ(E₁) the conductance Gᵢₜ(E₁) the capacitance Cᵢₜ(E₀), and the conductance Gᵢₜ(E₀) for the discrete interface states E1 and E0, which have been previously obtained, to obtain a new total value of the capacitance Cₜₒₜₐₗ.

Subsequently, if the first voltage V reaches a predetermined upper limit V_{end}, that is, +10 V being the upper limit of the input range (YES in step S110), the process ends. If the first voltage V does not reach the upper limit V_{end} (NO in step S110), the first voltage is incremented by Vₛₜₑₚ, that is, 0.1 V in step S111. As the first voltage changes, the value of k is incremented by 1. That is, among the multiple discrete interface states Eₖ, the interface state of interest in the next process is shifted to one deeper interface state. Then, the processes of steps S104 to S111 are repeated until the first voltage V reaches the upper limit V_{end}.

According to such a simulation method, with respect to the signal of the specific frequency f input as the parameter, the capacitance Cₜₒₜₐₗ of the laminated structure 101 is calculated for each 0.1 V in the range of the first voltage from −10 V to +10 V input as the parameter. That is, the C-V characteristic observed when the signal having the frequency f is applied to the metal 30 can be simulated. Then, by changing the value of the frequency f, the C-V characteristic can be obtained for multiple frequencies f, and the frequency dependence of the C-V characteristic can be analyzed. In calculating the capacitance Cₜₒₜₐₗ, by using the time constant τ (Eₖ) per discrete interface state Eₖ, a more accurate simulation can be performed.

Additionally, by using the first potential distribution 191 and the second potential distribution 192, the capacitance C_{S} can be obtained with higher accuracy, and by using the third potential distribution 193, the capacitance Cᵢₜ(Eₖ) can be obtained with higher accuracy.

Furthermore, by using the AC voltage in which the difference (dV) between the second voltage and the first voltage is equal to the difference (dV) between the first voltage and the third voltage, the capacitance C_{S} and the capacitance Cᵢₜ(Eₖ) can be easily calculated.

Here, a result of the simulation actually performed will be described. FIG. 17 is a cross-sectional view illustrating a laminated structure to be simulated. In this laminated structure, as illustrated in FIG. 17, a GaN layer 81A having a thickness of 900 nm is formed on an SiC substrate 80, and an n-type Al_{0.24}Ga_{0.76}N layer 81B having a thickness of 20 nm is formed on the GaN layer 81A. An Al₂O₃ film 82 having a thickness of 30 nm is formed on the Al_{0.24}Ga_{0.76}N layer 81B as a gate insulating film and a metal laminated body 83 of a Ni film and an Au film is formed on the Al₂O₃ film 82 as a gate electrode. Laminated bodies 84 of a Ti film, an Al film, a Ti film, and an Au film are formed at two locations on the Al_{0.24}Ga_{0.76}N layer 81B as a source electrode and a drain electrode. The diameter of the metal laminated body 83 in plan view is 200 μm. The GaN layer 81A and the Al_{0.24}Ga_{0.76}N layer 81B correspond to the semiconductor 10, the Al₂O₃ film 82 corresponds to the insulator 20, and the metal laminated body 83 corresponds to the metal 30. Here, the frequency of the signal applied to the metal laminated body 83 is 1 kHz, 10 kHz, 100 kHz, and 1 MHz.

FIG. 18 is a graph illustrating a simulation result of the laminated structure illustrated in FIG. 17. FIG. 19 is a graph illustrating an actual measurement result of the laminated structure illustrated in FIG. 17. FIG. 20 is a graph illustrating the simulation result and the actual measurement result, overlapping with each other. FIG. 20 illustrates enlarged portions of FIG. 18 and FIG. 19. The horizontal axis of each of FIGS. 18 to 20 represents the voltage applied to the metal laminated body 83 and the vertical axis represents the capacitance of the laminated structure. FIG. 18 and FIG. 19 also illustrate the Gₚ/ω-V characteristic in addition to the C-V characteristic. In FIG. 20, the simulation result is illustrated with thin lines and the actual measurement result is illustrated with thick lines. As illustrated in FIGS. 18 to 20, in the present embodiment, the simulation result equivalent to the actual measurement result is obtained.

The materials of the semiconductor 10, the insulator 20, and the metal 30 are not limited. The amplitude of the small AC voltage, the range of the DC bias, and the amount of change in the DC bias are not limited. For example, the amplitude of the small AC voltage may be 10 mV or greater and 15 mV or less.

According to the first embodiment, a simulation of a transistor including the semiconductor 10, the insulator 20, and the metal 30 can be performed. Examples of such a transistor include a MIS field effect transistor (FET), a metal-oxide-semiconductor (MOS) FET, a MIS-HEMT, a MOS-HEMT, and the like.

In the above-described embodiment, the conductivity type of the semiconductor 10 is n-type conductivity, but the conductivity type of the semiconductor 10 may be p-type conductivity. If the conductivity type of the semiconductor 10 is p-type conductivity, the polarity of the voltage may be reversed.

### Second Embodiment

A second embodiment also relates to a method of simulating a characteristic of a laminated structure including a semiconductor, an insulator and a metal. FIG. 21 is a cross-sectional view illustrating an object of a simulation method according to the second embodiment. As illustrated in FIG. 21, the object of the simulation method according to the second embodiment is a laminated structure 201 including a first semiconductor 10A, a second semiconductor 10B provided on the first semiconductor 10A, the insulator 20 provided on the second semiconductor 10B, and the metal 30 provided on the insulator 20. The laminated structure 201 has a MIS structure. For example, the first semiconductor 10A includes GaN 10AA and n-type AlGaN 10AB thereon, the second semiconductor 10B is GaN, and the insulator 20 is SiN or Al₂O₃. The thickness of the second semiconductor 10B is, for example, 1 nm or greater and 5 nm or less, and preferably 2 nm or greater and 4 nm or less. The second band gap of the second semiconductor 10B is smaller than the first band gap of the AlGaN 10AB.

FIG. 22 is a band diagram illustrating ideal potential distribution for the object of the simulation method according to the second embodiment. In FIG. 22, the vertical axis represents the magnitude of the electron energy, and the horizontal axis corresponds to the cross-sectional view of FIG. 21, and represents the distance in a direction perpendicular to the interface between the insulator 20 and the second semiconductor 10B, from the insulator 20 toward the second semiconductor 10B and the first semiconductor 10A. E_{V} represents the top of the highest energy band (i.e., a valence band) occupied by electrons in the band structure. E_{C} represents the bottom of the lowest empty energy band (i.e., a conduction band) in the band structure. E_{F} indicates the Fermi level. The example of FIG. 22 indicates that AlGaN 10AB is an n-type semiconductor, and a state in which the bias voltage V_{G} is applied to the metal 30, which is not illustrated in FIG. 22 (see FIG. 21).

In the laminated structure 201, the interface states are present at the interface between the second semiconductor 10B and the insulator 20, although not illustrated in FIG. 22. At the interface state, when a voltage is applied to the metal 30, electrons are trapped or emitted in accordance with the magnitude of the energy of the interface state. For example, when a small AC bias voltage that is a small AC voltage superimposed on the DC bias voltage is applied to the metal 30, the electron density of the first semiconductor 10A and the second semiconductor 10B is changed and the trap or emission of electrons at the interface state occurs.

As in the first embodiment, multiple interface states are represented as being discretely present in the second embodiment. In other words, multiple interface states are represented by using several discrete interface states Eₖ as being representatives.

In the second embodiment, for the laminated structure 201, a model including multiple discrete interface states, in which there is a quantum well of the second semiconductor 10B between the first semiconductor 10A and the insulator 20, is used. FIG. 23 is a band diagram illustrating potential distribution of the laminated structure 201 used in the simulation method according to the second embodiment. FIG. 24 is a diagram illustrating an equivalent circuit of the band structure illustrated in FIG. 23. The band diagram of FIG. 23 has multiple discrete interface states in comparison with the band diagram of FIG. 22. The example illustrated in FIG. 23 has five discrete interface states E₀, E₁, E₂, E₃, and E₄ in order from highest energy. Also, in the quantum well of the second semiconductor 10B, there is a ground level E_{X}.

As with the equivalent circuit illustrated in FIG. 6, the equivalent circuit illustrated in FIG. 24 has capacitance Cᵢₜ(Eₖ) and conductance Gᵢₜ(Eₖ) of the multiple interface states, connected in parallel, corresponding to the multiple discrete interface states Eₖ. The equations representing the capacitance Cₜₒₜₐₗ of the entirety of the laminated structure 201 derived from the equivalent circuit illustrated in FIG. 24 are represented as Eq. 6 to Eq. 9 above.

In the second embodiment, the capacitance C_{S} of the semiconductor 10 that is formed when the first voltage, for example, the DC bias V_{G} described above, is applied to the metal 30 is obtained using the model illustrated in FIG. 23 and FIG. 24 and the corresponding model equations of Eq. 6 to Eq. 9 to calculate the capacitance Cᵢₜ(Eₖ) at the multiple discrete interface states that is formed when the first voltage is applied to the metal 30 for each of the multiple discrete interface states Eₖ. The capacitance Cᵢₜ(Eₖ) is calculated from the quantity of electrons emitted into the quantum well from each of the capacitance Cᵢₜ(Eₖ) at the multiple discrete interface states when the voltage applied to the metal 30 changes.

Subsequently, the capacitance Cₜₒₜₐₗ of the laminated structure 201 that is formed when the first voltage is applied to the metal 30 is calculated using the capacitance C_{S} and the capacitance Cᵢₜ(Eₖ) for each of the multiple discrete interface states Eₖ.

As described, in the simulation method, the capacitance Cᵢₜ(Eₖ) for each of multiple discrete interface states Eₖ is calculated independently of the capacitance C_{S}. Then, according to the simulation method, the capacitance Cₜₒₜₐₗ of the laminated structure 201 at the first voltage can be calculated with high accuracy.

Additionally, by changing the first voltage in stages and calculating the capacitance Cᵢₜ(Eₖ) for each changed first voltage, the C-V characteristic can be obtained with high accuracy.

Further, by setting multiple frequencies of AC signals applied to the metal 30 and obtaining the C-V characteristic for each of these frequencies, the frequency dependence of the C-V characteristic, that is, the frequency dispersion can be analyzed.

The above-described simulation method may be performed using the simulation device 100 illustrated in FIG. 13 and FIG. 14, for example, as in the first embodiment. In the second embodiment, the simulation device 100 performs the simulation method based on the flowchart illustrated in FIG. 15.

Here, points that mainly differ from the first embodiment in the simulation method based on the flowchart (FIG. 15) will be described.

In the second embodiment, for example, the parameters obtained by the input data obtaining unit 41 in step S101 include a material, permittivity, a thickness, and a donor density of the first semiconductor 10A, a material, permittivity, a thickness, and a donor density of the second semiconductor 10B, and a material, permittivity, and a thickness of the insulator 20.

In step S102, the model equation obtaining unit 43 generates and obtains the model equations (Eq. 6 to Eq. 9), in which multiple discrete interface states Eₖ are included at the interface between the second semiconductor 10B and the insulator 20 and the quantum well of the second semiconductor 10B is present between the first semiconductor 10A and the insulator 20, by using information such as the materials of the first semiconductor 10A, the second semiconductor 10B, and the insulator 20.

As in the first embodiment, in step S104, the C_{S} calculating unit 44 calculates the first potential distribution formed when the voltage V_{G} of the metal 30 is the second voltage (V+dV) higher than the first voltage by dV, and electrons are trapped at at least one of the discrete interface states Eₖ. As in the first embodiment, in step S105, the C_{S} calculating unit 44 calculates the second potential distribution formed when the voltage V_{G} of the metal 30 is the third voltage (V-dV) lower than the first voltage by dV while electrons are trapped at at least one of the discrete interface states Eₖ.

FIG. 25 is a band diagram illustrating the first potential distribution 291 formed when the second voltage is applied to the metal 30 and the second potential distribution 292 formed when the third voltage is applied to the metal 30 arranged side by side. As illustrated in FIG. 25, in the second embodiment, when the first potential distribution 291 is compared with the second potential distribution 292, the energy of the first semiconductor 10A and the second semiconductor 10B in the second potential distribution 292 are higher than that in the first potential distribution 291.

In step S106, the C_{S} calculating unit 44 calculates the capacitance C_{S} of the first semiconductor 10A and the second semiconductor 10B by using the difference ΔQ of the quantity of electrons in the first semiconductor 10A and the second semiconductor 10B between the first potential distribution 291 and the second potential distribution 292, the difference ΔV (=2dV) between the second voltage and the third voltage, and the capacitance Cₒₓ of the insulator 20.

In step S107, the Cᵢₜ(Eₖ) calculating unit 45 calculates the third potential distribution 293 formed when the voltage V_{G} of the metal 30 is the third voltage (V−dV) and the time is t=1/(2πf). The energy of the first semiconductor 10A and the second semiconductor 10B in the third potential distribution 293 is lower than that in the second potential distribution 292. The present embodiment assumes that the density of electrons increases in the quantum well, rather than being trapped at discrete interface states Eₖ, as the potential distribution changes. FIG. 26 illustrates the second potential distribution and the third potential distribution.

In step S108, the Cᵢₜ(Eₖ) calculating unit 45 compares the second potential distribution 292 with the third potential distribution 293, calculates the electron quantity ΔQᵢₜ(Eₖ) of electrons emitted from each discrete interface state Eₖ during the time period Δt, and calculates the capacitance Cᵢₜ(Eₖ) for each discrete interface state Eₖ.

In step S109, the Cₜₒₜₐₗ calculating unit 46 calculates the capacitance Cₜₒₜₐₗ of the laminated structure 201 by using the capacitance C_{S} and the capacitance Cᵢₜ(Eₖ) for each of the multiple discrete interface states Eₖ.

Other processes are the same as the processes in the first embodiment.

Here, a result of the simulation actually performed will be described. FIG. 27 is a cross-sectional view illustrating a laminated structure to be simulated. In the laminated structure, as illustrated in FIG. 27, the GaN layer 81A having a thickness of 900 nm is formed on the SiC substrate 80, the n-type Al_{0.24}Ga_{0.76}N layer 81B having a thickness of 20 nm is formed on the GaN layer 81A, and a GaN capping layer 81C is famed on the Al_{0.24}Ga_{0.76}N layer 81B. The Al₂O₃ film 82 having a thickness of 30 nm is famed on the GaN capping layer 81C as a gate insulating layer and the metal laminated body 83 of an Ni film and an Au film is formed on the Al₂O₃ film 82 as a gate electrode. The laminated bodies 84 of a Ti film, an Al film, a Ti film and an Au film are formed at two locations on the GaN capping layer 81C as a source electrode and a drain electrode. The diameter of the metal laminated body 83 in plan view is 200 μm. The GaN layer 81A and the Al_{0.24}Ga_{0.76}N layer 81B correspond to the first semiconductor 10A, the GaN capping layer 81C corresponds to the second semiconductor 10B, the Al₂O₃ film 82 corresponds to the insulator 20, and the metal laminated body 83 corresponds to the metal 30. Here, the frequency of the signal applied to the metal laminated body 83 is 1 kHz, 10 kHz, 100 kHz, and 1 MHz.

FIG. 28 is a graph illustrating a simulation result of the laminated structure illustrated in FIG. 27. FIG. 29 is a graph illustrating an actual measurement result of the laminated structure illustrated in FIG. 27. FIG. 30 is a graph illustrating the simulation result and the actual measurement result, overlapping with each other. The horizontal axis of each of FIGS. 28 to 30 represents the voltage applied to the metal laminated body 83 and the vertical axis represents the capacitance of the laminated structure. FIGS. 28 to 30 illustrate the Gₚ/ω-V characteristic in addition to the C-V characteristic. In FIG. 30, the simulation result is illustrated with thin lines and the actual measurement result is illustrated with thick lines. As illustrated in FIGS. 28 to 30, the simulation result equivalent to the actual measurement result is obtained.

The materials of the first semiconductor 10A, the second semiconductor 10B, the insulator 20, and the metal 30 are not limited. The amplitude of the small AC voltage, the range of the DC bias, and the amount of change in the DC bias are not limited. For example, the amplitude of the small AC voltage may be 10 mV or greater and 15 mV or less.

According to a second embodiment, a simulation of a transistor including the first semiconductor 10A, the second semiconductor 10B, the insulator 20, and the metal 30 can be performed. Examples of such a transistor include MIS-HEMT, metal-oxide-semiconductor (MOS)-HEMT, and the like.

Although the embodiments have been described in detail above, the disclosure is not limited to particular embodiments, and various modifications and variations can be made within the scope of the claimed subject matter.

What is claimed is:

1. A method of simulating a capacitance-voltage (C-V) characteristic of a laminated structure including a semiconductor, an insulator provided on the semiconductor, and a metal provided on the insulator, the method using a model of the C-V characteristic of the laminated structure that includes a plurality of discrete interface states, at which electrons are trapped or emitted in response to a change of a voltage applied to the metal, at an interface between the semiconductor and the insulator, the model of the C-V characteristic representing a third capacitance in response to the change of the voltage, the third capacitance including a first capacitance of a depletion layer formed at the interface, a second capacitance of the plurality of discrete interface states, and a capacitance of the insulator, the first capacitance and the second capacitance being connected in parallel, the capacitance of the insulator being connected in series with the first capacitance and the second capacitance connected in parallel, and the method comprising:
calculating the first capacitance in accordance with a first voltage applied to the metal; and
calculating the second capacitance from a quantity of electrons emitted from a first interface state corresponding to the first voltage among the plurality of discrete interface states,
wherein the calculating of the second capacitance includes changing the first voltage in stages and shifting the first interface state in stages.

2. The method as claimed in claim 1, wherein a time constant for each of the plurality of discrete interface states is used to calculate the third capacitance.

3. The method as claimed in claim 1, wherein the calculating of the first capacitance includes:
calculating a first electron quantity in the semiconductor from a first potential distribution formed when a second voltage is applied to the metal and electrons are trapped at at least one of the plurality of interface states, the second voltage being higher than the first voltage;
calculating a second electron quantity in the semiconductor from a second potential distribution famed when a third voltage is applied to the metal while the electrons are trapped at the at least one of the plurality of interface states, the third voltage being lower than the first voltage; and
dividing a difference between the first electron quantity and the second electron quantity by a difference between the second voltage and the third voltage.

4. The method as claimed in claim 3, wherein the second capacitance is calculated from a third potential distribution formed when a predetermined time period has passed from a time when the second potential distribution is formed and the electrons are emitted from the at least one of the plurality of interface states.

5. The method as claimed in claim 3, wherein a difference between the second voltage and the first voltage is equal to a difference between the first voltage and the third voltage.

6. The method as claimed in claim 1, further comprising:
setting frequencies of alternating current signals applied to the metal; and
calculating the C-V characteristic of the laminated structure for each of the frequencies based on a relation between the first voltage and the third capacitance.

7. The method as claimed in claim 1,
wherein the semiconductor includes a first semiconductor having a first band gap and a second semiconductor having a second band gap smaller than the first band gap of the first semiconductor,
wherein the insulator is provided on the second semiconductor,
wherein the model of the C-V characteristic of the laminated structure includes a quantum well of the second semiconductor between the first semiconductor and the insulator, and
wherein the second capacitance is calculated from a quantity of electrons emitted into the quantum well from the first interface state corresponding to the first voltage among the plurality of discrete interface states.

8. A non-transitory computer-readable recording medium having stored therein a program for causing a computer to perform a process of simulating a capacitance-voltage (C-V) characteristic of a laminated structure including a semiconductor, an insulator provided on the semiconductor, and a metal provided on the insulator, the process using a model of the C-V characteristic of the laminated structure that includes a plurality of discrete interface states, at which electrons are trapped or emitted in response to a change of a voltage applied to the metal, at an interface between the semiconductor and the insulator, the model of the C-V characteristic representing a third capacitance in response to the change of the voltage, the third capacitance including a first capacitance of a depletion layer formed at the interface, a second capacitance of the plurality of discrete interface states, and a capacitance of the insulator, the first capacitance and the second capacitance being connected in parallel, the capacitance of the insulator being connected in series with the first capacitance and the second capacitance connected in parallel, and the process comprising:
calculating the first capacitance in accordance with a first voltage applied to the metal;
calculating the second capacitance from a quantity of electrons emitted from a first interface state corresponding to the first voltage among the plurality of discrete interface states;
calculating the third capacitance; and
changing the first voltage in stages and shifting the first interface state in stages.

9. A device of simulating a capacitance-voltage (C-V) characteristic of a laminated structure including a semiconductor, an insulator provided on the semiconductor, and a metal provided on the insulator, by using a model of the C-V characteristic of the laminated structure that includes a plurality of discrete interface states, at which electrons are trapped or emitted in response to a change of a voltage applied to the metal, at an interface between the semiconductor and the insulator, the model of the C-V characteristic representing a third capacitance in response to the change of the voltage, the third capacitance including a first capacitance of a depletion layer foamed at the interface, a second capacitance of the plurality of discrete interface states, and a capacitance of the insulator, the first capacitance and the second capacitance being connected in parallel, the capacitance of the insulator being connected in series with the first capacitance and the second capacitance connected in parallel, and the device comprising:
a processor; and
a memory storing program instructions that cause the processor to:
calculate the first capacitance in accordance with a first voltage applied to the metal;
calculate the second capacitance from a quantity of electrons emitted from a first interface state corresponding to the first voltage among the plurality of discrete interface states, and
calculate the third capacitance,
wherein the processor changes the first voltage in stages and shifts the first interface state in stages, and the processor calculates a total capacitance value from the first capacitance, the second capacitance calculated for each changed first voltage, and the capacitance of the insulator.
